(19) United States
(12) Patent Application Publication
(10) Pub. No.: US 2025/0053108 A1
(43) Pub. Date: Feb. 13, 2025

(54) CARRIER FOR ELECTROSTATIC IMAGE DEVELOPMENT, ELECTROSTATIC IMAGE DEVELOPER, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Yasuo KADOKURA, Kanagawa (JP); Yosuke TSURUMI, Kanagawa (JP); Moegi IGUCHI, Kanagawa (JP); Ryo NAGAI, Kanagawa (JP); Sakon TAKAHASHI, Kanagawa (JP)

(73) Assignee: FUJIFILM Business Innovation Corp., Tokyo (JP)

(21) Appl. No.: 18/780,861

(22) Filed: Jul. 23, 2024

(30) Foreign Application Priority Data
Aug. 10, 2023 (JP) 2023-131600
Aug. 10, 2023 (JP) 2023-131601

(51) Int. Cl. G03G 9/113; G03G 9/08; G03G 9/107

(52) U.S. Cl. CPC G03G 9/1139; G03G 9/0819; G03G 9/1085; G03G 9/1133; G03G 2215/0607; G03G 2221/183

(57) ABSTRACT

A carrier for electrostatic image development includes magnetic particles having internal pores, and a resin composition disposed in at least some of the internal pores and containing a resin and inorganic particles including at least one selected from the group consisting of silica, alumina, and calcium carbonate.

### CROSS-REFERENCE TO RELATED APPLICATIONS

This application is based on and claims priority under 35 USC 119 from Japanese Patent Application No. 2023-131600 filed Aug. 10, 2023 and Japanese Patent Application No. 2023-131601 filed Aug. 10, 2023.

### BACKGROUND

### (i) Technical Field

The present disclosure relates to a carrier for electrostatic image development, an electrostatic image developer, a process cartridge, an image forming apparatus, and an image forming method.

### (ii) Related Art

Japanese Unexamined Patent Application Publication No. 2019-061188 discloses a carrier for electrophotographic development including a carrier core and a resin covering the surface of the carrier core, the carrier core being constituted by ferrite particles, having a specific pore volume, and having an average internal pore area in a specific range, wherein the proportion of internal pores with a pore area of 20 m² or more is 1.8% or less.

Japanese Unexamined Patent Application Publication No. 2021-051216 discloses a carrier for electrostatic image development including a core and a coating resin layer that contains nitrogen-containing resin particles and inorganic oxide particles and covers the core, wherein the surface exposure rate of the nitrogen-containing resin particles is 0.8% or more and 3.0% or less.

Japanese Unexamined Patent Application Publication No. 2007-058124 discloses a carrier for electrostatic latent image development including core particles and a resin coating layer in which conductive fine particles are dispersed, the carrier having an average particle size of 25 to 60 μm and an average circularity of 0.975 or more, the core particles having a BET specific surface area of 0.1 to 0.3 m²/g and an internal porosity of 10% or less.

### SUMMARY

Aspects of non-limiting embodiments of the present disclosure relate to a carrier for electrostatic image development by which density unevenness of an image formed by a developing system in which an AC voltage is applied in a high-temperature and high-humidity environment is suppressed, compared with the case where no inorganic particles are contained in internal pores of magnetic particles.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a carrier for electrostatic image development, comprising:
magnetic particles having internal pores; and
a resin composition disposed in at least some of the internal pores and containing a resin and inorganic particles including at least one selected from the group consisting of silica, alumina, and calcium carbonate.

### BRIEF DESCRIPTION OF THE DRAWINGS

Exemplary embodiments of the present disclosure will be described in detail based on the following figures, wherein:

FIG. 1 is a schematic view for explaining how to determine the presence of internal pores of magnetic particles;

FIG. 2 illustrates a schematic configuration of an example of an image forming apparatus according to an exemplary embodiment; and

FIG. 3 illustrates a schematic configuration of an example of a process cartridge attachable to and detachable from an image forming apparatus according to an exemplary embodiment.

### DETAILED DESCRIPTION

Exemplary embodiments of the present disclosure will be described below. The description and examples below are illustrative of the exemplary embodiments and are not intended to limit the scope of the exemplary embodiments.

In the present disclosure, a numerical range expressed using “to” indicates a range including the numerical values before and after “to” as the minimum value and the maximum value.

In numerical ranges described in stages in the present disclosure, the upper limit or the lower limit described in one numerical range may be replaced with the upper limit or the lower limit of other numerical ranges described in stages. In a numerical range described in the present disclosure, the upper limit or the lower limit of the numerical range may be replaced with a value described in Examples.

The term “step” in the present disclosure encompasses not only a separate step but also a step that is not clearly distinguished from another step if the desired object of the step is achieved.

When an exemplary embodiment is described with reference to the drawings in the present disclosure, the configuration of the exemplary embodiment is not limited to the configuration illustrated in the drawings. In addition, the size of members in figures is conceptual, and the relative size relationship between the members is not limited thereto.

In the present disclosure, components may each include a plurality of corresponding substances. In the present disclosure, if there are two or more substances corresponding to one component in a composition, the amount of the component in the composition refers to the total amount of the two or more substances present in the composition unless otherwise specified.

In the present disclosure, a plurality of types of particles corresponding to each component may be contained. When a plurality of types of particles corresponding to each component are present in the composition, the particle size of each component means the value of a mixture of the plurality of types of particles present in the composition unless otherwise specified.

In the present disclosure, “(meth)acrylic” means at least one of acrylic and methacrylic, and “(meth)acrylate” means at least one of acrylate and methacrylate.

In the present disclosure, “toner for electrostatic image development” is also referred to as “toner”, and “carrier for electrostatic image development” is also referred to as “carrier”, and “electrostatic image developer” is also referred to as “developer”.

### Carrier for Electrostatic Image Development

A carrier for electrostatic image development according to an exemplary embodiment includes magnetic particles having internal pores, and a resin composition disposed in at least some of the internal pores and containing a resin and inorganic particles including at least one selected from the group consisting of silica, alumina, and calcium carbonate. The carrier according to the exemplary embodiment may optionally further include a resin coating layer covering the magnetic particles.

Hereinafter, at least one selected from the group consisting of silica, alumina, and calcium carbonate is also referred to as “specific inorganic particles”, and a resin composition containing the specific inorganic particles and a resin is also referred to as a “specific resin composition”.

In the exemplary embodiment, the presence of the specific resin composition in the internal pores of the magnetic particles suppresses density unevenness of an image formed by a developing system in which an AC voltage is applied in a high-temperature and high-humidity environment. Although the reason is not clear, it is presumed as follows.

One cause of density unevenness of an image formed by a developing system in which an AC voltage is applied is poor responsiveness of a carrier to the AC voltage. In particular, the higher the dielectric constant of the entire carrier, the more likely the response to the AC voltage will be delayed in a high-temperature and high-humidity environment, resulting in an increased likelihood of image unevenness.

Another cause of density unevenness of an image formed by a developing system in which an AC voltage is applied is cracking, chipping, or the like of the magnetic particles serving as a core of the carrier. The cracking and chipping of the magnetic particles are caused by, for example, mechanical stress due to stirring in a developing device. The occurrence of cracking, chipping, or the like of the magnetic particles results in a change in chargeability at a part of the carrier, which causes regions with different densities in an image formed, resulting in image unevenness.

By contrast, in the exemplary embodiment, the specific resin composition containing the specific inorganic particles is disposed in the internal pores of the magnetic particles. The specific inorganic particles have a low relative dielectric constant, and thus the presence thereof in the internal pores of the magnetic particles leads to a low dielectric constant of the entire carrier, improving the responsiveness to an AC voltage. As a result of the improvement in the responsiveness to an AC voltage, the voltage varies little and the toner adhesion is nearly uniform if a solid image is formed in, for example, a high-temperature and high-humidity environment, which presumably suppresses density unevenness.

In addition, the presence of the resin in the internal pores of the magnetic particles leads to reduced mechanical stress due to the elasticity of the resin, suppressing cracking and chipping of the magnetic particles. As a result of the suppression of cracking and chipping of the magnetic particles, the occurrence of image unevenness due to cracking, chipping, or the like of the magnetic particles is presumably suppressed.

For the above reasons, it is presumed that density unevenness of an image formed by a developing system in which an AC voltage is applied in a high-temperature and high-humidity environment is suppressed in the exemplary embodiment.

Hereinafter, the carrier according to the exemplary embodiment will be described in detail.

### Magnetic Particles

The magnetic particles are not limited as long as they are magnetic particles having internal pores.

Specific examples of the magnetic particles include particles of magnetic oxides such as ferrite and magnetite. The magnetic particles are preferably magnetic oxide particles, more preferably ferrite particles.

From the viewpoint of suppression of image unevenness, the internal porosity of the magnetic particles is preferably 2% or more and 10% or less, more preferably 2% or more and 8% or less, still more preferably 3% or more and 6% or less.

When the internal porosity of the magnetic particles is equal to or higher than the above lower limit, the specific inorganic particles tend to be present in the internal pores of the magnetic particles, resulting in a low dielectric constant of the entire carrier. As a result, the responsiveness to an AC voltage improves, and the occurrence of density unevenness of an image formed by a developing system in which an AC voltage is applied in a high-temperature and high-humidity environment is suppressed.

When the internal porosity of the magnetic particles is equal to or lower than the above upper limit, cracking, chipping, or the like of the magnetic particles due to mechanical stress is unlikely to occur, and the occurrence of image unevenness due to such cracking, chipping, or the like is suppressed.

When the magnetic particles are, for example, ferrite particles, the internal porosity of the magnetic particles may be controlled in the above range by, for example, oxygen concentration during firing and firing temperature. Specifically, the internal porosity is increased by raising the oxygen concentration or lowering the firing temperature.

The determination of whether the magnetic particles have internal pores and the calculation of the internal porosity of the magnetic particles are performed as described below.

First, the carrier is embedded in an embedding agent such as an epoxy resin to obtain an embedded product, and then a surface of the embedded product is cut with a diamond knife or the like. The cutting is continued to a place where a cross section of a magnetic particle is sufficiently secured to prepare a measurement sample, and an image of the cross section is captured. The capturing of an image of the cross section may be performed by a method known in the art such as scanning electron microscopy (SEM).

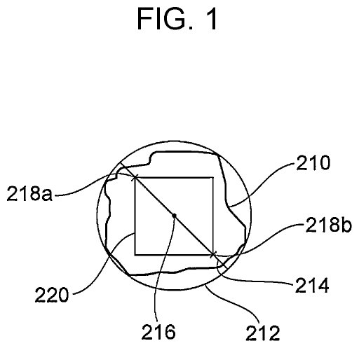

Next, the cross section of the magnetic particle is analyzed using image analysis software known in the art (e.g., WinRoof (MITANI CORPORATION)). Specifically, as illustrated in FIG. 1, in a square 220 having two points 218a and 218b as two opposite vertices, the two points 218a and 218b lying on one diameter 214 of a particle circumcircle 212 of a magnetic particle cross section 210 and being distant from a center 216 of the circumcircle 212 by ¾ of the radius, the presence of a pore (i.e., a space where the magnetic particle component is absent) is determined.

The determination of whether the magnetic particles have internal pores is carried out by subjecting 100 magnetic particles to the above analysis of a magnetic particle cross section to determine whether a pore is present in the square 220. In an SEM image of a magnetic particle cross section, a pore appears as a black region.

When it is determined that a pore is present in the square 220 in cross sections of 90 or more magnetic particles, the magnetic particles are regarded as having internal pores.

The internal porosity (%) of the magnetic particles is calculated by the following formula. In the following formula, SH represents the total area of pores present in the square 220 in 100 magnetic particles, and ST represents the total area of the square 220 in the 100 magnetic particles.

$$internal porosity ( \% ) = ( SH / ST ) \times 100 \qquad Formula$$

As the one diameter 214 of the particle circumcircle 212 of the magnetic particle cross section 210, a diameter at any given position is selected. The magnetic particle cross section 210 to be measured may be a cross section taken near the center of the magnetic particle.

For the toner-carrier adhesion to be appropriate so as to provide a sufficient amount of toner development and for a suitable magnetic brush to be provided so as to form an image with high fine-line reproducibility, the number-average particle size of the magnetic particles is preferably 15 μm or more and 100 μm or less, more preferably 20 μm or more and 80 μm or less, still more preferably 30 μm or more and 60 μm or less.

The number-average particle size of the magnetic particles is determined by analyzing cross sections of 100 magnetic particles similarly to the above-described method of determining the presence of internal pores in the magnetic particles. Specifically, the equivalent circle diameter of the cross section 210 of each particle is determined, and values of the 100 particles are averaged to determine the number-average particle size of the magnetic particles.

For the magnetic force of the magnetic particles, the saturation magnetization in a magnetic field at 3000 oersteds is preferably 50 emu/g or more, more preferably 60 emu/g or more. The saturation magnetization is measured using a Vibrating Sample Magnetometer VSMP10-15 (manufactured by Toei Industry Co., Ltd.). A measurement sample is packed in a cell having an inner diameter of 7 mm and a height of 5 mm and put in the apparatus. In the measurement, a magnetic field is applied and swept to a maximum of 3000 oersteds. Next, the applied magnetic field is decreased to prepare a hysteresis curve on recording paper. From the data of the curve, saturation magnetization, residual magnetization, and coercivity are determined.

The volume electrical resistance (volume resistivity) of the magnetic particles is preferably 1×10⁵ Ω·cm or more and 1×10⁹ Ω·cm or less, more preferably 1×10⁷ Ω·cm or more and 1×10⁹ Ω·cm or less.

The volume electrical resistance (Ω·cm) of the magnetic particles is measured in the following manner. On a surface of a circular jig provided with a 20 cm² electrode plate, a measurement target is flatly placed so as to be 1 mm to 3 mm thick to form a layer. Another 20 cm² electrode plate is placed thereon to sandwich the layer. To remove gaps between the particles of the measurement target, a load of 4 kg is applied onto the electrode plate placed on the layer before the thickness (cm) of the layer is measured. The two electrodes above and below the layer are connected with an electrometer and a high-voltage power generator. A high voltage is applied across the two electrodes so as to generate an electric field of 103.8 V/cm, and the current (A) flowing at this time is read out. The measurement is performed in an environment at a temperature of 20° C. and a relative humidity of 50%. The calculation formula for the volume electrical resistance (Ω·cm) of the measurement target is as shown below.

$$R = E \times 20 / ( I - {I}_{0} ) / L$$

In the formula, R represents the volume electrical resistance (Ω·cm) of the measurement target, E represents the applied voltage (V), I represents the current (A), I₀ represents the current (A) at an applied voltage of 0 V, and L represents the thickness (cm) of the layer. The coefficient 20 represents the area (cm²) of each electrode plate.

### Specific Resin Composition

The specific resin composition is disposed in at least some of the internal pores of the magnetic particles. The magnetic particles at least have an internal pore in which the specific resin composition is disposed, and may further have an internal pore in which the specific resin composition is not disposed. The internal pore in which the specific resin composition is not disposed includes an internal pore in which the resin alone is disposed, an internal pore in which the specific inorganic particles alone are disposed, and an internal pore in which neither the resin nor the specific inorganic particles are disposed.

The determination of whether the specific resin composition is disposed in the internal pores of the magnetic particles is performed by observing and analyzing a cross section of the magnetic particles similarly to the above-described method of determining the presence of internal pores in the magnetic particles. For example, when the specific inorganic particles are silica particles, a cross section of the internal pores of the magnetic particles is subjected to an elemental analysis by energy-dispersive X-ray spectroscopy (EDX), and a region where silica is present is determined by mapping a region where silicon is present, whereas a region where the resin is present is determined by mapping a region where carbon is present. When the specific inorganic particles are alumina particles, a region where an aluminum element is present is mapped, and when the specific inorganic particles are calcium carbonate particles, a region where a calcium element is present is mapped.

The specific resin composition at least contains the specific inorganic particles and the resin and may further contain other components.

The determination of whether the specific resin composition and the resin coating layer are connected to each other is performed by observing a cross section of the carrier in the same manner as the determination of whether the specific resin composition is disposed in the internal pores of the magnetic particles.

### Specific Inorganic Particles

The specific inorganic particles contained in the specific resin composition are at least one selected from the group consisting of silica, alumina, and calcium carbonate. The specific inorganic particles may be constituted by only one kind of inorganic particles or two or more kinds of inorganic particles. In particular, the specific inorganic particles may include silica from the viewpoint of lowering the dielectric constant of the entire carrier and suppressing density unevenness.

The surface of the specific inorganic particles may be subjected to hydrophobic treatment. When the specific inorganic particles include silica, the hydrophobizing agent may be, for example, a known organosilicon compound having an alkyl group (e.g., a methyl group, an ethyl group, a propyl group, or a butyl group), and specific examples include alkoxysilane compounds, siloxane compounds, and silazane compounds. Of these, the hydrophobizing agent is preferably a silazane compound, more preferably hexamethyldisilazane. The hydrophobizing agent may be used alone or in combination of two or more.

The hydrophobic treatment helps the inorganic particles be homogeneously dispersed in the resin composition, thus lowering the dielectric constant of the entire carrier, so that density unevenness is suppressed.

Examples of methods of hydrophobizing the specific inorganic particles with a hydrophobizing agent include a method in which supercritical carbon dioxide is used, and a hydrophobizing agent is dissolved in supercritical carbon dioxide to cause the hydrophobizing agent to adhere to the surface of the specific inorganic particles; a method in which, in the air, a solution including a hydrophobizing agent and a solvent for dissolving the hydrophobizing agent is applied (e.g., sprayed or coated) onto the surface of the specific inorganic particles to cause the hydrophobizing agent to adhere to the surface of the specific inorganic particles; and a method in which, in the air, a solution including a hydrophobizing agent and a solvent for dissolving the hydrophobizing agent is added to a specific inorganic particle dispersion, the resultant is held, and then the mixed solution of the specific inorganic particle dispersion and the solution is dried.

From the viewpoint of suppression of density unevenness, the number-average particle size of the specific inorganic particles is preferably 5 nm or more and 90 nm or less, more preferably 5 nm or more and 50 nm or less, still more preferably 7 nm or more and 50 nm or less.

When the number-average particle size of the specific inorganic particles is in this range, compared with the case where it is above or below the range, cracking, chipping, or the like of the magnetic particles due to mechanical stress is less likely to occur, and the occurrence of image unevenness due to such cracking, chipping, or the like is suppressed.

The number-average particle size of the specific inorganic particles is determined by analyzing a cross section of the magnetic particles similarly to the above-described method of determining the presence of internal pores in the magnetic particles. Specifically, equivalent circle diameters of 100 specific inorganic particles present in the internal pores of the magnetic particles are determined and averaged to determine the number-average particle size of the specific inorganic particles.

Observation and analysis may be performed with a field-emission scanning electron microscope (FE-SEM) capable of high-resolution imaging. Specific examples of such FE-SEMs include Regulus series “SU8010”, “Regulus8100”, “Regulus8220”, “Regulus8230”, “Regulus8240”, and “ULTRA55” from Hitachi High-Tech Corporation and “JSM-IT800” from JEOL Ltd.

As the number-average particle size of the inorganic particles contained in the specific resin composition and the resin coating layer, the number-average particle size of the inorganic particles measured with a laser diffraction/scattering particle size distribution analyzer may be used.

The amount of the specific inorganic particles contained in the specific resin composition may be such an amount that the ratio of the total area of the specific inorganic particles to the total area of the resin in a cross section of the specific resin composition is 0.02 or more and 0.10 or less.

Hereinafter, the ratio of the total area SP of the specific inorganic particles to the total area SR of the resin in a cross section of the specific resin composition is also referred to as an area ratio (SP/SR). The area ratio (SP/SR) is preferably 0.02 or more and 0.10 or less, more preferably 0.03 or more and 0.08 or less, still more preferably 0.04 or more and 0.06 or less.

When the area ratio (SP/SR) is equal to or higher than the above lower limit, the dielectric constant of the entire carrier tends to be low. This improves the responsiveness to an AC voltage, and the occurrence of density unevenness of an image formed by a developing system in which an AC voltage is applied in a high-temperature and high-humidity environment is suppressed.

When the area ratio (SP/SR) is equal to or lower than the above upper limit, the resin present in the internal pores of the magnetic particles reduces mechanical stress to reduce the likelihood of cracking, chipping, or the like of the magnetic particles, and the occurrence of image unevenness due to such cracking, chipping, or the like is suppressed.

The area ratio (SP/SR) is determined by analyzing cross sections of 100 pieces of the specific resin composition included in the internal pores of the magnetic particles similarly to the above-described method of determining whether the specific resin composition is disposed in the internal pores of the magnetic particles. Specifically, the total area of regions of the specific inorganic particles and the total area of regions of the resin in 100 pieces of the specific resin composition are determined to calculate the area ratio (SP/SR).

### Resin

Examples of the resin contained in the specific resin composition include styrene-acrylic acid copolymers; polyolefin resins such as polyethylene and polypropylene; polyvinyl or polyvinylidene resins such as polystyrene, (meth)acrylic resin, polyacrylonitrile, polyvinyl acetate, polyvinyl alcohol, polyvinyl butyral, polyvinyl chloride, polyvinylcarbazole, polyvinyl ether, and polyvinyl ketone; vinyl chloride-vinyl acetate copolymers; straight silicone resins having organosiloxane bonds and modified products thereof; fluorocarbon resins such as polytetrafluoroethylene, polyvinyl fluoride, polyvinylidene fluoride, and polychlorotrifluoroethylene; polyester; polyurethane; polycarbonate; amino resins such as urea-formaldehyde resin; and epoxy resins.

In particular, from the viewpoint of increasing the affinity for the inorganic particles to lower the dielectric constant of the carrier, thus resulting in suppression of density unevenness, the resin contained in the specific resin composition preferably includes (meth)acrylic resin, more preferably includes (meth)acrylic resin in an amount of 50 mass % or more relative to the total mass of the resin in the specific resin composition, and particularly preferably includes (meth)acrylic resin in an amount of 80 mass % or more relative to the total mass of the resin in the specific resin composition.

From the viewpoint of increasing the affinity for the inorganic particles to lower the dielectric constant of the carrier, thus resulting in suppression of density unevenness, the specific resin composition may contain a (meth)acrylic resin having an alicyclic structure. The (meth)acrylic resin having an alicyclic structure at least includes, as a polymerization component, a polymerization component having an alicyclic structure. Among polymerization components of the (meth)acrylic resin having an alicyclic structure, the polymerization component having an alicyclic structure may be an alicyclic alkyl ester of (meth)acrylic acid (e.g., an ester of (meth)acrylic acid and an alcohol having an alicyclic structure having 3 to 9 carbon atoms), specifically, cyclohexyl (meth)acrylate.

The (meth)acrylic resin having an alicyclic structure may be a copolymer of a polymerization component having an alicyclic structure and a polymerization component not having an alicyclic structure. The polymerization component not having an alicyclic structure may be a lower alkyl ester of (meth)acrylic acid (e.g., a (meth)acrylic acid alkyl ester having an alkyl group having 1 to 9 carbon atoms), and specific examples include methyl (meth)acrylate, ethyl (meth)acrylate, propyl (meth)acrylate, butyl (meth)acrylate, hexyl (meth)acrylate, and 2-ethylhexyl (meth)acrylate. These monomers may be used alone or in combination of two or more.

The (meth)acrylic resin having an alicyclic structure may include cyclohexyl (meth)acrylate as a polymerization component. The content of a monomer unit derived from cyclohexyl (meth)acrylate included in the (meth)acrylic resin having an alicyclic structure is preferably 75 mass % or more and 100 mass % or less, more preferably 85 mass % or more and 100 mass % or less, still more preferably 95 mass % or more and 100 mass % or less relative to the total mass of the (meth)acrylic resin having an alicyclic structure.

The resin contained in the specific resin composition may include a resin having a nitrogen atom from the viewpoint of suppression of density unevenness. The presence of a resin having a nitrogen atom in the specific resin composition improves the chargeability in a high-humidity environment to suppress the occurrence of density unevenness of an image due to low charging in a high-temperature and high-humidity environment.

Examples of the resin having a nitrogen atom include (meth)acrylic resins having a nitrogen atom that are obtained by polymerization of dimethylaminoethyl (meth)acrylate, dimethylacrylamide, acrylonitrile, etc.; amino resins such as urea, melamine, guanamine, and aniline; amide resins; urethane resins; and copolymers of these resins. Of these, from the viewpoint of further suppression of density unevenness of an image, the resin having a nitrogen atom is preferably a (meth)acrylic resin having a nitrogen atom, more preferably a (meth)acrylic resin having an amino group, still more preferably a polymer including dimethylaminoethyl (meth)acrylate as a polymerization component.

The resin contained in the specific resin composition, when including a resin having a nitrogen atom, may further include a resin not having a nitrogen atom from the viewpoint of suppression of an environmental difference in image density. When a resin not having a nitrogen atom is further included, moisture is appropriately adsorbed, and an increase in charging particularly under low humidity can be prevented, thus suppressing an environmental difference in image density.

The resin not having a nitrogen atom may be a resin not having a nitrogen atom among the specific examples of the resin given above, and is preferably a (meth)acrylic resin not having a nitrogen atom, more preferably a (meth)acrylic resin not having a nitrogen atom and having an alicyclic structure, still more preferably a polymer including cyclohexyl (meth)acrylate as a polymerization component.

When the specific resin composition contains both a resin having a nitrogen atom and a resin not having a nitrogen atom, the content of the resin having a nitrogen atom is preferably in the range of 0.2 mass % or more and 5.0 mass % or less, more preferably in the range of 0.3 mass % or more and 3.0 mass % or less relative to the total mass of the resin in the specific resin composition.

From the viewpoint of adhesiveness to the magnetic particles, the weight-average molecular weight of the resin contained in the specific resin composition is preferably less than 300,000, more preferably less than 250,000, still more preferably 5,000 or more and less than 250,000, particularly preferably 10,000 or more and 200,000 or less.

Here, the weight-average molecular weight is determined by gel permeation chromatography (GPC). The molecular weight determination by GPC is performed using an HLC-8120 system manufactured by Tosoh Corporation as a measurement apparatus, a TSKgel SuperHM-M column (15 cm) manufactured by Tosoh Corporation, and a THF solvent. The weight-average molecular weight is calculated using a molecular weight calibration curve prepared from the measurement results relative to monodisperse polystyrene standards.

### Conductive Particles

The specific resin composition may further contain conductive particles as other components in addition to the specific inorganic particles and the resin. The term “conductive” in the conductive particles refers to having a volume resistivity of less than 1×10⁷ Ω·cm at 20° C.

However, the specific resin composition preferably does not contain conductive particles or contains the conductive particles such that the ratio of the total area of the conductive particles to the total area of the specific inorganic particles is 0.005 or less in a cross section of the specific resin composition. Hereinafter, the ratio of the total area SC of the conductive particles to the total area SP of the specific inorganic particles in a cross section of the specific resin composition is also referred to as the area ratio (SC/SP). The area ratio (SC/SP) is preferably 0 or more and 0.005 or less, more preferably 0 or more and 0.004 or less.

When the area ratio (SC/SP) is equal to or lower than the above upper limit, few highly conductive components are present in the internal pores of the magnetic particles, and the dielectric constant of the entire carrier tends to be low. This improves the responsiveness to an AC voltage, and the occurrence of density unevenness of an image formed by a developing system in which an AC voltage is applied in a high-temperature and high-humidity environment is suppressed.

When the carrier according to the exemplary embodiment includes the resin coating layer described later, the resin coating layer may contain the conductive particles such that the area ratio (SC/SP) in the specific resin composition is in the above range, from the viewpoint of suppressing density unevenness while controlling the resistance of the carrier.

Examples of the conductive particles include carbon black and conductive inorganic particles (e.g., titanium oxide) other than carbon black.

The number-average particle size of the conductive particles is, for example, 20 nm or more and 100 nm or less, and is preferably 30 nm or more and 80 nm or less, more preferably 30 nm or more and 50 nm or less.

### Disposition in Internal Pores

The specific resin composition may be disposed in the internal pores of the magnetic particles by, for example, using a resin liquid for specific resin composition disposition obtained by dissolving or dispersing the resin, the specific inorganic particles, and other components contained in the specific resin composition in a solvent. Specifically, for example, the resin liquid for specific resin composition disposition and the magnetic particles having internal pores may be mixed and stirred at a high temperature (e.g., 75° C. or higher and 95° C. or lower) and a reduced pressure (e.g., a gauge pressure of −96 kPa to −81 kPa).

When the carrier includes the resin coating layer described later, a resin liquid for resin coating layer formation described later may be used as the resin liquid for specific resin composition disposition to form the resin coating layer and also dispose the specific resin composition in the internal pores.

### Resin Coating Layer

The carrier according to the exemplary embodiment may further include a resin coating layer covering the magnetic particles having internal pores in which the specific resin composition is disposed.

In the exemplary embodiment, the resin coating layer contains inorganic particles, and the specific resin composition is disposed in the internal pores of the magnetic particles, so that the adhesion of the carrier for electrostatic image development to an image carrying member is suppressed when an image with a high area coverage is continuously formed over a long period of time at high temperature and high humidity.

If an image with a high area coverage is continuously formed over a long period of time, the carrier may undergo great mechanical stress due to stirring in a developing device, resulting in the occurrence of peeling off of the resin coating layer and cracking, chipping, or the like of the magnetic particles. The occurrence of peeling off of the resin coating layer or cracking, chipping, or the like of the magnetic particles results in exposure of the magnetic particles, which increases the likelihood that charge injection into the carrier occurs particularly at high temperature and high humidity (e.g., in an environment at 28° C. and 85% RH), and as a result of being charged, the carrier becomes more likely to adhere to an image carrying member.

On the other hand, the filler effect of the inorganic particles contained in the resin coating layer makes the resin coating layer harder and improves the strength of the resin coating layer, and the anchoring effect of the specific resin composition that have entered the internal pores makes the adhesion of the resin coating layer stronger and also improves the strength of the magnetic particles themselves. Presumably, suppression of peeling off of the resin coating layer and cracking, chipping, or the like of the magnetic particles leads to suppression of charge injection at high temperature and high humidity due to exposure of the magnetic particles, resulting in suppression of the adhesion to an image carrying member due to charging of the carrier.

The specific resin composition present in the internal pores of the magnetic particles and the resin coating layer covering the surface of the magnetic particles may be connected to each other. When the specific resin composition and the resin coating layer are connected to each other, peeling off of the resin coating layer is further suppressed, thus suppressing the adhesion of the carrier to an image carrying member.

The resin coating layer may contain the resin and the specific inorganic particles contained in the specific resin composition.

The resin coating layer may further contain other components. The inorganic particles contained in the specific resin composition and the inorganic particles contained in the resin coating layer may be of the same type. Specifically, the specific resin composition and the resin coating layer may contain inorganic particles made of the same material and surface treated by the same method. The resin contained in the specific resin composition and the resin contained in the resin coating layer may be of the same type. Specifically, the specific resin composition and the resin coating layer may contain resins having the same main backbone.

In particular, the inorganic particles contained in the specific resin composition and the resin coating layer may include silica particles. That is, both the inorganic particles contained in the specific resin composition and the inorganic particles contained in the resin coating layer may include silica. When silica particles are included as the inorganic particles contained in the specific resin composition and the resin coating layer, variation in image density is suppressed when an image with a high area coverage is continuously formed over a long period of time at high temperature and high humidity. Although the reason is not clear, it is presumably because the presence of silica particles in the specific resin composition and the resin coating layer helps maintain the charging characteristics of the carrier.

When the number-average particle size of the inorganic particles is in the above-mentioned range, the filler effect of the inorganic particles contained in the resin coating layer and the anchoring effect of the inorganic particles contained in the specific resin composition are readily produced, thus suppressing the adhesion of the carrier to an image carrying member. When the number-average particle size of the inorganic particles is equal to or lower than the above upper limit, the inorganic particles readily enter the internal pores of the magnetic particles, and the anchoring effect of the inorganic particles that have entered the internal pores are readily produced, thus suppressing the adhesion of the carrier to an image carrying member.

From the viewpoint of increasing the affinity for the inorganic particles to produce their filler effect and anchoring effect and achieve, in particular, high hardness, the resin coating layer may contain a (meth)acrylic resin having an alicyclic structure. The (meth)acrylic resin having an alicyclic structure at least includes, as a polymerization component, a polymerization component having an alicyclic structure. Among polymerization components of the (meth)acrylic resin having an alicyclic structure, the polymerization component having an alicyclic structure may be an alicyclic alkyl ester of (meth)acrylic acid (e.g., an ester of (meth)acrylic acid and an alcohol having an alicyclic structure having 3 to 9 carbon atoms), specifically, cyclohexyl (meth)acrylate. Details of the resin and the specific inorganic particles contained in the resin coating layer are as described above.

From the viewpoint of making the resin coating layer moderately penetrate into the internal pores, the content of the specific inorganic particles contained in the resin coating layer is preferably 10 mass % or more and 60 mass % or less, more preferably 15 mass % or more and 55 mass % or less, still more preferably 20 mass % or more and 50 mass % or less relative to the total mass of the resin coating layer.

The amount of the inorganic particles contained in the specific resin composition may be such an amount that the ratio of the total area of the inorganic particles contained in the specific resin composition to the entire area of the specific resin composition (hereinafter also referred to as the “area ratio B”) in a cross section of the specific resin composition is 0.5% or more and 15% or less. The area ratio B is more preferably 1% or more and 12% or less, still more preferably 2% or more and 10% or less.

When the area ratio B is equal to or higher than the above lower limit, the anchoring effect of the inorganic particles contained in the specific resin composition is readily produced, thus suppressing the adhesion of the carrier to an image carrying member. When the area ratio B is equal to or lower than the above upper limit, mechanical stress tends to be reduced by the elasticity of the resin contained in the specific resin composition, and cracking, chipping, or the like of the magnetic particles is suppressed, thus suppressing the adhesion of the carrier to an image carrying member.

The area ratio B is determined by analyzing cross sections of 100 pieces of the specific resin composition included in the internal pores of the magnetic particles similarly to the above-described method of determining whether the specific resin composition is disposed in the internal pores of the magnetic particles. Specifically, in 100 pieces of the specific resin composition, the entire area of the specific resin composition and the total area of regions of the inorganic particles contained in the specific resin composition are determined to calculate the area ratio B.

The amount of the inorganic particles contained in the resin coating layer may be such an amount that the ratio of the total area of the inorganic particles contained in the resin coating layer to the entire area of the resin coating layer (hereinafter also referred to as the “area ratio A”) in a cross section of the resin coating layer is 10% or more and 50% or less. The area ratio A is more preferably 20% or more and 45% or less, still more preferably 25% or more and 40% or less.

When the area ratio A is equal to or higher than the above lower limit, the filler effect of the inorganic particles contained in the resin coating layer is readily produced, thus suppressing the adhesion of the carrier to an image carrying member. When the area ratio A is equal to or lower than the above upper limit, the binding force of the resin contained in a large amount in the resin coating layer improves the strength of the resin coating layer to suppress peeling off and the like of the resin coating layer, thus suppressing the adhesion of the carrier to an image carrying member.

The area ratio A is determined by analyzing cross sections of 100 carriers similarly to the above-described method of determining the presence of internal pores in the magnetic particles. Specifically, in the resin coating layer in a cross section of each particle, the entire area of the resin coating layer and the total area of regions of the inorganic particles contained in the resin coating layer are determined to calculate the area ratio A.

The area ratio A and the area ratio B may satisfy the relationship of area ratio A>area ratio B from the viewpoint of suppression of the adhesion of the carrier to an image carrying member. In particular, the area ratio A may be in the above range and satisfy area ratio A>area ratio B from the viewpoint of suppression of the adhesion of the carrier to an image carrying member.

When area ratio A>area ratio B is satisfied, the filler effect of the inorganic particles contained in the resin coating layer is produced, while a decrease in the anchoring effect due to too small an amount of the resin of the specific resin composition entering the internal pores of the magnetic particles is suppressed. That is, both the filler effect and the anchoring effect are efficiently produced, thus suppressing the adhesion of the carrier to an image carrying member.

The area ratio B may be 0.05 to 0.3 times the area ratio A from the viewpoint of suppression of the adhesion of the carrier to an image carrying member. That is, the value of area ratio B/area ratio A is preferably 0.05 to 0.3. The value of area ratio B/area ratio A is more preferably 0.07 to 0.25, still more preferably 0.1 to 0.2. When the value of area ratio B/area ratio A is equal to or higher than the above lower limit, the anchoring effect of the inorganic particles contained in the specific resin composition is readily produced, thus suppressing the adhesion of the carrier to an image carrying member. When the value of area ratio B/area ratio A is equal to or lower than the above upper limit, a decrease in the anchoring effect due to too small an amount of the resin of the specific resin composition entering the internal pores of the magnetic particles is suppressed, thus suppressing the adhesion of the carrier to an image carrying member.

From the viewpoint of resistance control, the resin coating layer may contain the conductive particles described above. Details of the conductive particles contained in the resin coating layer are as described above.

From the viewpoint of an appropriate resistance value, the content of the conductive particles contained in the resin coating layer is preferably 0.5 mass % or more and 15 mass % or less, more preferably 2 mass % or more and 10 mass % or less, still more preferably 3 mass % or more and 8 mass % or less relative to the total mass of the resin coating layer.

The resin coating layer may optionally contain other components.

Examples of the other components include nitrogen-containing resin particles and inorganic particles other than the specific inorganic particles.

The presence of nitrogen-containing resin particles in the resin coating layer has the benefit of producing an improvement in charging speed.

Examples of the nitrogen-containing resin particles include particles of (meth)acrylic resins obtained by polymerization of dimethylaminoethyl (meth)acrylate, dimethylacrylamide, acrylonitrile, etc.; amino resins such as urea, melamine, guanamine, and aniline; amide resins; urethane resins; copolymers of these resins; and the like. When the resin coating layer contains nitrogen-containing resin particles, from the viewpoint of the improvement in charging speed and the ability to be taken into a coat layer, the content of the nitrogen-containing resin particles is preferably 5 mass % or more and 20 mass % or less, more preferably 8 mass % or more and 16 mass % or less, still more preferably 9 mass % or more and 14 mass % or less relative to the total mass of the resin coating layer.

Examples of the inorganic particles other than the specific inorganic particles include particles of metal oxides such as titanium oxide (titania), barium titanate, magnesium titanate, calcium titanate, strontium titanate, iron oxide, copper oxide, zinc oxide, tin oxide, chromium oxide, cerium oxide, antimony trioxide, magnesium oxide, and zirconium oxide; particles of metal compounds such as barium sulfate, barium carbonate, aluminum borate, and potassium titanate; and particles of metals such as gold, silver, and copper.

In the exemplary embodiment, carbon black is regarded as not being inorganic particles. When the resin coating layer contains inorganic particles other than the specific inorganic particles, the content of the inorganic particles other than the specific inorganic particles may be 0.1 mass % or less relative to the total mass of the resin coating layer from the viewpoint of lowering the relative dielectric constant the entire carrier to suppress density unevenness.

From the viewpoint of resistance and charging performance, the average thickness of the resin coating layer is preferably 0.6 μm or more and 1.4 μm or less, more preferably 0.8 m or more and 1.2 μm or less, particularly preferably 0.8 μm or more and 1.1 μm or less.

The average thickness of the resin coating layer is determined by analyzing cross sections of 100 carriers similarly to the above-described method of determining the presence of internal pores in the magnetic particles. Specifically, the thickness of the resin coating layer in a cross section of each particle is determined at nine points for each particle, and all of the thicknesses at nine points in each of the 100 particles are averaged to determine the average thickness of the resin coating layer.

Examples of methods of forming the resin coating layer on the surface of the magnetic particles include a wet process and a dry process. The wet process is a process that uses a solvent in which a resin for forming the resin coating layer is dissolved or dispersed. The dry process is a process that does not use such a solvent.

Examples of the wet process include a dipping process in which the magnetic particles are dipped in a resin liquid for resin coating layer formation to form a coating; a spray process in which a resin liquid for resin coating layer formation is sprayed onto the surface of the magnetic particles; a fluidized bed process in which the magnetic particles fluidized in a fluidized bed are sprayed with a resin liquid for resin coating layer formation; and a kneader-coater process in which the magnetic particles and a resin liquid for resin coating layer formation are mixed in a kneader-coater and the solvent is removed. These processes may be repeated or combined.

The resin liquid for resin coating layer formation used in the wet process is prepared by dissolving or dispersing the resin, the inorganic particles, and other components in a solvent. Non-limiting examples of the solvent include aromatic hydrocarbons such as toluene and xylene; ketones such as acetone and methyl ethyl ketone; and ethers such as tetrahydrofuran and dioxane.

One example of the dry process is a process in which a mixture of the magnetic particles and a resin for resin coating layer formation is heated in a dry state to form the resin coating layer. Specifically, for example, the magnetic particles and the resin for resin coating layer formation are mixed in the gas phase and melted by heating to form the resin coating layer.

The formation of the resin coating layer may be performed along with the above-described process of disposing the specific resin composition in the internal pores of the magnetic particles, or may be performed separately from the disposition of the specific resin composition. When the formation of the resin coating layer is performed separately from the disposition of the specific resin composition, the formation of the resin coating layer is performed by any of the above processes using, for example, the magnetic particles having internal pores in which the specific resin composition is disposed.

Specifically, for example, a first resin liquid in which the concentrations of both the inorganic particles and the resin are low is used, and after the first resin liquid and the magnetic particles are mixed, a second resin liquid in which the concentrations of both the inorganic particles and the resin are higher than in the first resin liquid is added and mixed. In this method, the inorganic particles and the resin readily enter the internal pores of the magnetic particles in the step of mixing the first resin liquid and the magnetic particles, and the resin coating layer is readily formed in the subsequent step of adding and mixing the second resin liquid. Thus, a carrier in which the specific resin composition is disposed in the internal pores of the magnetic particles and the resin coating layer is formed on the surface of the magnetic particles is readily obtained.

Hereinafter, as an exemplary method of the disposition of the specific resin composition and the formation of the resin coating layer, a method including a first step of mixing the first resin liquid and the magnetic particles and a second step of adding the second resin liquid to the mixture of the first resin liquid and the magnetic particles and further mixing them will be described.

The first resin liquid and the second resin liquid are each prepared by dissolving or dispersing the resin, the inorganic particles, and optional other components in a solvent as described above.

Non-limiting examples of the solvent include aromatic hydrocarbons such as toluene and xylene; ketones such as acetone and methyl ethyl ketone; and ethers such as tetrahydrofuran and dioxane. The solvent contained in the first resin liquid and the solvent contained in the second resin liquid may be the same or different, and is preferably the same.

The concentration of the inorganic particles in the first resin liquid may be, for example, 0.05 mass % or more and 10 mass % or less relative to the total mass of the resin liquid, and is preferably 0.07 mass % or more and 5 mass % or less, more preferably 0.1 mass % or more and 3 mass % or less.

The concentration of the inorganic particles in the second resin liquid may be, for example, 1 mass % or more and 20 mass % or less relative to the total mass of the resin liquid, and is preferably 2 mass % or more and 15 mass % or less, more preferably 3 mass % or more and 10 mass % or less.

The concentration of the inorganic particles in the first resin liquid is preferably 0.01 to 0.8 times, more preferably 0.02 to 0.6 times, still more preferably 0.03 to 0.4 times the concentration of the inorganic particles in the second resin liquid.

The concentration of the resin in the first resin liquid may be, for example, 0.5 mass % or more and 20 mass % or less relative to the total mass of the resin liquid, and is preferably 1 mass % or more and 15 mass % or less, more preferably 2 mass % or more and 10 mass % or less.

The concentration of the resin in the second resin liquid may be, for example, 3 mass % or more and 30 mass % or less relative to the total mass of the resin liquid, and is preferably 4 mass % or more and 25 mass % or less, more preferably 5 mass % or more and 20 mass % or less.

The concentration of the resin in the first resin liquid is preferably 0.1 to 0.9 times, more preferably 0.2 to 0.8 times, still more preferably 0.3 to 0.7 times the concentration of the resin in the second resin liquid.

The viscosity of the first resin liquid at 25° C. may be, for example, 5 mPa·s or more and 50 mPa-s or less, and is preferably 10 mPa-s or more and 40 mPa-s or less, more preferably 12 mPa·s or more and 30 mPa·s or less.

The viscosity of the second resin liquid at 25° C. may be, for example, 30 mPa·s or more and 120 mPa-s or less, and is preferably 35 mPa-s or more and 100 mPa-s or less, more preferably 40 mPa·s or more and 80 mPa·s or less.

The viscosity of the first resin liquid at 25° C. is preferably 0.05 to 0.6 times, more preferably 0.1 to 0.5 times, still more preferably 0.2 to 0.4 times the viscosity of the second resin liquid at 25° C.

The measurement of the viscosity of the resin liquids at 25° C. is performed in the following manner. Specifically, the viscosity is measured using an oscillational viscometer by dipping a detection probe in each resin liquid.

The conditions in the first step may be, for example, as follows: temperature, 30° C. or higher and 70° C. or lower; time, 10 minutes or more and 60 minutes or less; pressure (gauge pressure), −30 kPa to 0 kPa.

The conditions in the second step may be, for example, as follows: temperature, 70° C. or higher and 90° C. or lower; time, 10 minutes or more and 120 minutes or less; pressure (gauge pressure), −95 kPa to −70 kPa.

The method including the first step and the second step may optionally further include other steps. Examples of the other steps include a step of removing the solvent after the second step and a step of removing fine powder and coarse powder of the resulting particles.

The exposed area ratio of the magnetic particles on the surface of the carrier is preferably 5% or more and 30% or less, more preferably 7% or more and 25% or less, still more preferably 10% or more and 25% or less. The exposed area ratio of the magnetic particles on the carrier can be controlled by the amount of the resin used to form the resin coating layer, and as the amount of the resin relative to the amount of the magnetic particle increases, the exposed area ratio decreases.

The exposed area ratio of the magnetic particles on the carrier surface is a value determined in the following manner.

The target carrier and the magnetic particles, which are obtained by removing the resin coating layer from the target carrier, are provided. Examples of methods of removing the resin coating layer from the carrier include removing the resin coating layer by dissolving the resin component with an organic solvent and removing the resin coating layer by eliminating the resin component by heating at about 800° C. Using the carrier and the magnetic particles as measurement samples, the Fe concentration (atomic %) on the surface of each sample is quantitatively determined by XPS, and (Fe concentration of carrier)/(Fe concentration of magnetic particles)×100 is calculated to determine the exposed area ratio (%) of the magnetic particles.

For the toner-carrier adhesion to be appropriate so as to provide a sufficient amount of toner development and for a suitable magnetic brush to be provided so as to form an image with high fine-line reproducibility, the number-average particle size of the carrier is preferably 15 μm or more and 100 μm or less, more preferably 20 μm or more and 80 μm or less, particularly preferably 25 μm or more and 40 μm or less. The number-average particle size of the carrier is determined in the same manner as the number-average particle size of the magnetic particles described above.

Electrostatic Image Developer A developer according to an exemplary embodiment is a two-component developer including the carrier for electrostatic image development according to the exemplary embodiment and a toner. The toner includes toner particles and optionally an external additive.

The mixing ratio (mass ratio) of the carrier and the toner in the developer is preferably carrier:toner=100:1 to 100:30, more preferably 100:3 to 100:20.

### Toner Particles

The toner particles include, for example, a binder resin and optionally a colorant, a release agent, and other additives.

Binder Resin Examples of the binder resin include vinyl resins formed of homopolymers of monomers such as styrenes (e.g., styrene, p-chlorostyrene, and a-methylstyrene), (meth)acrylates (e.g., methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (e.g., acrylonitrile and methacrylonitrile), vinyl ethers (e.g., vinyl methyl ether and vinyl isobutyl ether), vinyl ketones (e.g., vinyl methyl ketone, vinyl ethyl ketone, and vinyl isopropenyl ketone), and olefins (e.g., ethylene, propylene, and butadiene); and vinyl resins formed of copolymers of two or more of these monomers.

Other examples of the binder resin include non-vinyl resins such as epoxy resins, polyester resins, polyurethane resins, polyamide resins, cellulose resins, polyether resins, and modified rosins; mixtures of these non-vinyl resins and the above vinyl resins; and graft polymers obtained by polymerization of vinyl monomers in the presence of these non-vinyl resins.

These binder resins may be used alone or in combination of two or more.

The binder resin may be a polyester resin.

Examples of the polyester resin include known amorphous polyester resins. The polyester resin may be a combination of an amorphous polyester resin with a crystalline polyester resin. The crystalline polyester resin may be used in an amount of 2 mass % or more and 40 mass % or less (preferably 2 mass % or more and 20 mass % or less) relative to the total mass of the binder resin.

“Crystalline” in the context of a resin means that the resin shows a distinct endothermic peak, rather than a stepwise endothermic change, in differential scanning calorimetry (DSC), and specifically means that the half-width of the endothermic peak measured at a temperature increase rate of 10° C./min is within 10° C.

“Amorphous” in the context of a resin means that the half-width exceeds 10° C., that a stepwise endothermic change is shown, or that no distinct endothermic peak is observed.

### Amorphous Polyester Resin

Examples of the amorphous polyester resin include polycondensates of polycarboxylic acids with polyhydric alcohols. The amorphous polyester resin for use may be a commercially available product or may be synthesized.

Examples of the polycarboxylic acids include aliphatic dicarboxylic acids (e.g., oxalic acid, malonic acid, maleic acid, fumaric acid, citraconic acid, itaconic acid, glutaconic acid, succinic acid, alkenylsuccinic acid, adipic acid, and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), anhydrides thereof, and lower (e.g., C1 to C5)alkyl esters thereof. Of these, aromatic dicarboxylic acids are preferred, for example.

The polycarboxylic acid may be a combination of a dicarboxylic acid with a trivalent or higher valent carboxylic acid having a cross-linked or branched structure. Examples of the trivalent or higher valent carboxylic acid include trimellitic acid, pyromellitic acid, anhydrides thereof, and lower (e.g., C1 to C5)alkyl esters thereof.

These polycarboxylic acids may be used alone or in combination of two or more.

Examples of the polyhydric alcohols include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic diols (e.g., ethylene oxide adducts of bisphenol A and propylene oxide adducts of bisphenol A). Of these, aromatic diols and alicyclic diols are preferred, for example, and aromatic diols are more preferred.

The polyhydric alcohol may be a combination of a diol with a trivalent or higher valent polyhydric alcohol having a cross-linked or branched structure. Examples of the trivalent or higher valent polyhydric alcohol include glycerol, trimethylolpropane, and pentaerythritol.

These polyhydric alcohols may be used alone or in combination of two or more.

The glass transition temperature (Tg) of the amorphous polyester resin is preferably 50° C. or higher and 80° C. or lower, more preferably 50° C. or higher and 65° C. or lower. The glass transition temperature is determined from a DSC curve obtained by differential scanning calorimetry (DSC), and is more specifically determined in accordance with “Extrapolation Glass Transition Onset Temperature” described in Determination of Glass Transition Temperature in JIS K 7121: 1987 “Testing Methods for Transition Temperatures of Plastics”.

The weight-average molecular weight (Mw) of the amorphous polyester resin is preferably 5,000 or more and 1,000,000 or less, more preferably 7,000 or more and 500,000 or less.

The number-average molecular weight (Mn) of the amorphous polyester resin is preferably 2,000 or more and 100,000 or less.

The molecular weight distribution Mw/Mn of the amorphous polyester resin is preferably 1.5 or more and 100 or less, more preferably 2 or more and 60 or less. The weight-average molecular weight and the number-average molecular weight are determined by gel permeation chromatography (GPC). The molecular weight determination by GPC is performed using an HLC-8120GPC system manufactured by Tosoh Corporation as a measurement apparatus, a TSKgel SuperHM-M column (15 cm) manufactured by Tosoh Corporation, and a THF solvent. The weight-average molecular weight and the number-average molecular weight are calculated using a molecular weight calibration curve prepared from the measurement results relative to monodisperse polystyrene standards.

The amorphous polyester resin is obtained by a known production method. Specifically, the amorphous resin is obtained by, for example, performing a reaction at a polymerization temperature of 180° C. or higher and 230° C. or lower, optionally while removing water and alcohol produced during condensation by reducing the pressure in the reaction system.

If any starting monomer is insoluble or incompatible at the reaction temperature, it may be dissolved by adding a high-boiling solvent as a solubilizer. In this case, the polycondensation reaction is performed while the solubilizer is distilled off. If a poorly compatible monomer is present in the copolymerization reaction, the poorly compatible monomer may be condensed in advance with an acid or alcohol to be polycondensed with the monomer before being polycondensed with the major components.

### Crystalline Polyester Resin

Examples of the crystalline polyester resin include polycondensates of polycarboxylic acids with polyhydric alcohols. The crystalline polyester resin for use may be a commercially available product or may be synthesized.

To easily form a crystalline structure, the crystalline polyester resin may be a polycondensate obtained using linear aliphatic polymerizable monomers rather than aromatic polymerizable monomers.

Examples of the polycarboxylic acids include aliphatic dicarboxylic acids (e.g., oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (e.g., dibasic acids such as phthalic acid, isophthalic acid, terephthalic acid, and naphthalene-2,6-dicarboxylic acid), anhydrides thereof, and lower (e.g., C1 to C5)alkyl esters thereof.

The polycarboxylic acid may be a combination of a dicarboxylic acid with a trivalent or higher valent carboxylic acid having a cross-linked or branched structure. Examples of the tricarboxylic acid include aromatic carboxylic acids (e.g., 1,2,3-benzenetricarboxylic acid, 1,2,4-benzenetricarboxylic acid, and 1,2,4-naphthalenetricarboxylic acid), anhydrides thereof, and lower (e.g., C1 to C5)alkyl esters thereof.

The polycarboxylic acid may be a combination of such a dicarboxylic acid with a dicarboxylic acid having a sulfonic group or a dicarboxylic acid having an ethylenic double bond.

These polycarboxylic acids may be used alone or in combination of two or more.

Examples of the polyhydric alcohols include aliphatic diols (e.g., linear aliphatic diols having 7 to 20 main-chain carbon atoms). Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Of these, 1,8-octanediol, 1,9-nonanediol, and 1,10-decanediol are preferred.

The polyhydric alcohol may be a combination of a diol with a trivalent or higher valent alcohol having a cross-linked or branched structure. Examples of the trivalent or higher valent alcohol include glycerol, trimethylolethane, trimethylolpropane, and pentaerythritol.

These polyhydric alcohols may be used alone or in combination of two or more.

The amount of aliphatic diol contained in the polyhydric alcohol may be 80 mol % or more, and is preferably 90 mol % or more.

The melting temperature of the crystalline polyester resin is preferably 50° C. or higher and 100° C. or lower, more preferably 55° C. or higher and 90° C. or lower, still more preferably 60° C. or higher and 85° C. or lower.

The melting temperature is determined from a DSC curve obtained by differential scanning calorimetry (DSC) in accordance with “Melting Peak Temperature” described in Determination of Melting Temperature of JIS K 7121: 1987 “Testing Methods for Transition Temperatures of Plastics”.

The weight-average molecular weight (Mw) of the crystalline polyester resin may be 6,000 or more and 35,000 or less.

The crystalline polyester resin is produced by, for example, a known method, as with the amorphous polyester.

The content of the binder resin is preferably 40 mass % or more and 95 mass % or less, more preferably 50 mass % or more and 90 mass % or less, still more preferably 60 mass % or more and 85 mass % or less relative to the total mass of the toner particles.

### Colorant

Examples of the colorant include pigments such as carbon black, chromium yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

These colorants may be used alone or in combination of two or more.

Optionally, the colorant may be a surface-treated colorant or may be used in combination with a dispersant. The colorant may be a combination of different colorants.

The content of the colorant is preferably 1 mass % or more and 30 mass % or less, more preferably 3 mass % or more and 15 mass % or less relative to the total mass of the toner particles.

### Release Agent

Examples of the release agent include hydrocarbon waxes; natural waxes such as carnauba wax, rice wax, and Candelilla wax; synthetic or mineral/petroleum waxes such as montan wax; and ester waxes such as fatty acid esters and montanic acid esters. The release agent is not limited thereto.

The melting temperature of the release agent is preferably 50° C. or higher and 110° C. or lower, more preferably 60° C. or higher and 100° C. or lower.

The melting temperature is determined from a DSC curve obtained by differential scanning calorimetry (DSC) in accordance with “Melting Peak Temperature” described in Determination of Melting Temperature of JIS K 7121: 1987 “Testing Methods for Transition Temperatures of Plastics”.

The content of the release agent is preferably 1 mass % or more and 20 mass % or less, more preferably 5 mass % or more and 15 mass % or less relative to the total mass of the toner particles.

### Other Additives

Examples of other additives include known additives such as magnetic materials, charge control agents, and inorganic powders. These additives are contained as internal additives in the toner particles.

### Properties of Toner Particles

The toner particles may be toner particles having a single-layer structure or toner particles having what is called a core-shell structure composed of a core (core particle) and a coating layer (shell layer) covering the core.

The toner particles having a core-shell structure may be composed of, for example, a core and a coating layer, the core containing a binder resin and other optional additives such as a colorant and a release agent, the coating layer containing a binder resin.

The volume-average particle size (D50v) of the toner particles is preferably 2 μm or more and 10 μm or less, more preferably 4 μm or more and 8 μm or less.

The volume-average particle size (D50v) of the toner particles is measured using a COULTER MULTISIZER II (manufactured by Beckman Coulter, Inc.) and an ISOTON-II electrolyte solution (manufactured by Beckman Coulter, Inc.).

In the measurement, 0.5 mg or more and 50 mg or less of a test sample is added into 2 ml of a 5 mass % aqueous solution of a surfactant (e.g., sodium alkylbenzenesulfonate) serving as a dispersant. The resulting solution is added into 100 ml or more and 150 ml or less of the electrolyte solution.

The electrolyte solution in which the sample is suspended is dispersed with an ultrasonic disperser for 1 minute, and the particle size distribution of particles having a particle size of 2 μm or more and 60 μm or less is measured with the COULTER MULTISIZER II using an aperture with an aperture size of 100 μm. The number of sampled particles is 50,000. A volume-based particle size distribution is drawn from the small particle size side, and a particle size at a cumulative volume of 50% is determined as the volume-average particle size D50v.

The average circularity of the toner particles is preferably 0.94 or more and 1.00 or less, more preferably 0.95 or more and 0.98 or less.

The average circularity of the toner particles is determined by (peripheral length of equivalent circle)/(peripheral length) [(peripheral length of circle having same projected area as that of particle image)/(peripheral length of projected particle image)]. Specifically, the average circularity is measured in the following manner.

First, target toner particles are collected by suction to form a flat flow, and strobe light is flashed to capture a still particle image, which particle image is analyzed with a flow particle image analyzer (FPIA-3000 manufactured by Sysmex Corporation). The number of particles sampled for determining the average circularity is 3,500.

When the toner contains an external additive, the toner (developer) to be measured is dispersed in water containing a surfactant and then sonicated to obtain toner particles from which the external additive has been removed.

### Method for Producing Toner Particles

The toner particles may be produced by a dry process (e.g., kneading pulverization) or a wet process (e.g., aggregation and coalescence, suspension polymerization, or dissolution suspension). These processes are not particularly limited, and a known process is employed. Of these, aggregation and coalescence may be used to obtain the toner particles.

Specifically, for example, when the toner particles are produced by aggregation and coalescence, they are produced by the following steps: a step (a resin particle dispersion preparing step) of preparing a resin particle dispersion in which resin particles serving as a binder resin are dispersed; a step (an aggregated particle forming step) of aggregating the resin particles (optionally, other particles) in the resin particle dispersion (optionally, the dispersion that has been mixed with another particle dispersion) to form aggregated particles; and a step (a fusion and coalescence step) of heating the aggregated particle dispersion, in which the aggregated particles are dispersed, to fuse and coalesce the aggregated particles, thereby forming toner particles.

The steps will be described below in detail.

Although a method for obtaining toner particles containing a colorant and a release agent will be described below, the colorant and the release agent are optional. It should be understood that additives other than the colorant and the release agent may also be used.

### Resin Particle Dispersion Preparing Step

A resin particle dispersion in which resin particles serving as a binder resin are dispersed as well as, for example, a colorant particle dispersion in which colorant particles are dispersed and a release agent particle dispersion in which release agent particles are dispersed are prepared.

The resin particle dispersion is prepared by, for example, dispersing resin particles in a dispersion medium with a surfactant.

The dispersion medium used for the resin particle dispersion may be, for example, an aqueous medium.

Examples of the aqueous medium include water, such as distilled water and ion-exchange water, and alcohols. These may be used alone or in combination of two or more.

Examples of the surfactant include anionic surfactants such as sulfate ester salts, sulfonate salts, phosphate esters, and soaps; cationic surfactants such as amine salts and quaternary ammonium salts; and nonionic surfactants such as polyethylene glycol, alkylphenol-ethylene oxide adducts, and polyhydric alcohols. Of these, in particular, anionic surfactants and cationic surfactants may be used. Nonionic surfactants may be used in combination with an anionic surfactant or a cationic surfactant.

These surfactants may be used alone or in combination of two or more.

In preparing the resin particle dispersion, the resin particles may be dispersed in a dispersion medium by a commonly used dispersion technique, for example, a rotary shear homogenizer or a media mill such as a ball mill, a sand mill, or a Dyno-Mill. Depending on the type of the resin particles, the resin particles may be dispersed in the dispersion medium by phase-inversion emulsification. Phase-inversion emulsification is a process in which a resin to be dispersed is dissolved in a hydrophobic organic solvent capable of dissolving the resin, a base is added to the organic continuous phase (0-phase) to cause neutralization, and then an aqueous medium (W-phase) is added to cause phase inversion from W/O to O/W, whereby the resin is dispersed in particulate form in the aqueous medium.

The volume-average particle size of the resin particles dispersed in the resin particle dispersion is, for example, preferably 0.01 μm or more and 1 μm or less, more preferably 0.08 m or more and 0.8 μm or less, still more preferably 0.1 μm or more and 0.6 μm or less. The volume-average particle size of the resin particles is determined as follows: using a particle size distribution obtained by measurement with a laser diffraction particle size distribution analyzer (e.g., LA-700 manufactured by Horiba, Ltd.), a cumulative volume distribution is plotted against divided particle size ranges (channels) from the small particle size side, and a particle size at a cumulative percentage of 50% relative to all particles is determined as the volume-average particle size D50v. The volume-average particle sizes of particles in other dispersions are determined in the same manner.

The content of the resin particles in the resin particle dispersion is preferably 5 mass % or more and 50 mass % or less, more preferably 10 mass % or more and 40 mass % or less.

In the same manner as the resin particle dispersion, for example, the colorant particle dispersion and the release agent particle dispersion are also prepared. That is, the volume-average particle size of particles, the dispersion medium, the dispersion technique, and the content of the particles in the resin particle dispersion also apply to the colorant particles dispersed in the colorant particle dispersion and the release agent particles dispersed in the release agent particle dispersion.

### Aggregated Particle Forming Step

Next, the resin particle dispersion, the colorant particle dispersion, and the release agent particle dispersion are mixed together.

The resin particles, the colorant particles, and the release agent particles are then allowed to undergo heteroaggregation in the mixed dispersion to form aggregated particles including the resin particles, the colorant particles, and the release agent particles, the aggregated particles having a size close to the desired size of the toner particles.

Specifically, the aggregated particles are formed by, for example, adding an aggregating agent to the mixed dispersion while adjusting the mixed dispersion to an acidic pH (e.g., a pH of 2 to 5), optionally adding a dispersion stabilizer, and then heating the mixed dispersion to a temperature close to the glass transition temperature of the resin particles (specifically, for example, from the glass transition temperature of the resin particles minus 30° C. to the glass transition temperature minus 10° C.), thereby aggregating the particles dispersed in the mixed dispersion.

In the aggregated particle forming step, for example, heating may be performed after adding an aggregating agent to the mixed dispersion at room temperature (e.g., 25° C.) while stirring with a rotary shear homogenizer, adjusting the mixed dispersion to an acidic pH (e.g., a pH of 2 to 5), and optionally adding a dispersion stabilizer.

Examples of the aggregating agent include surfactants having polarity opposite to that of the surfactant contained in the mixed dispersion, inorganic metal salts, and metal complexes with a valence of two or more. When a metal complex is used as the aggregating agent, the amount of surfactant used is reduced, resulting in improved charging characteristics.

Together with the aggregating agent, additives that form a complex or a similar linkage together with metal ions of the aggregating agent may optionally be used. As such additives, chelating agents are suitable for use.

Examples of the inorganic metal salts include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

The chelating agent may be a water-soluble chelating agent. Examples of the chelating agent include oxycarboxylic acids such as tartaric acid, citric acid, and gluconic acid; and aminocarboxylic acids such as iminodiacetic acid (IDA), nitrilotriacetic acid (NTA), and ethylenediaminetetraacetic acid (EDTA).

The amount of chelating agent added is preferably 0.01 parts by mass or more and 5.0 parts by mass or less, more preferably 0.1 parts by mass or more and less than 3.0 parts by mass relative to 100 parts by mass of the resin particles.

### Fusion and Coalescence Step

Next, the aggregated particle dispersion in which the aggregated particles are dispersed is heated, for example, at or above the glass transition temperature of the resin particles (e.g., a temperature that is 10° C. to 30° C. higher than the glass transition temperature of the resin particles) to fuse and coalesce the aggregated particles, thereby forming toner particles.

Through the above steps, the toner particles are obtained.

The toner particles may also be produced through a step of, after obtaining an aggregated particle dispersion in which aggregated particles are dispersed, further mixing the aggregated particle dispersion with a resin particle dispersion in which resin particles are dispersed and aggregating the resin particles such that the resin particles further adhere to the surface of the aggregated particles to form second aggregated particles; and a step of fusing and coalescing the second aggregated particles by heating the second aggregated particle dispersion in which the second aggregated particles are dispersed to form toner particles having a core-shell structure.

After the completion of the fusion and coalescence step, the toner particles formed in the solution are subjected to known washing, solid-liquid separation, and drying steps to obtain dry toner particles. The washing step may be performed by sufficient displacement washing with ion-exchange water from the viewpoint of charging characteristics. The solid-liquid separation step may be performed by, for example, suction filtration or pressure filtration from the viewpoint of productivity. The drying step may be performed by, for example, freeze drying, flash drying, fluidized bed drying, or vibrating fluidized bed drying from the viewpoint of productivity.

The toner according to the exemplary embodiment is produced by, for example, adding an external additive to the dry toner particles obtained and mixing them together. The mixing may be performed with, for example, a V-blender, a Henschel mixer, or a Loedige mixer. Optionally, coarse toner particles may be removed using, for example, a vibrating screen or an air screen.

### External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

The surface of inorganic particles used as an external additive may be subjected to hydrophobic treatment. The hydrophobic treatment may be performed by, for example, immersing the inorganic particles in a hydrophobizing agent. Non-limiting examples of the hydrophobizing agent include silane coupling agents, silicone oil, titanate coupling agents, and aluminum coupling agents. These hydrophobizing agents may be used alone or in combination of two or more.

The amount of hydrophobizing agent is typically, for example, 1 part by mass or more and 10 parts by mass or less relative to 100 parts by mass of the inorganic particles.

Other examples of the external additive include resin particles (particles of resins such as polystyrene, polymethyl methacrylate, and melamine resins) and cleaning active agents (e.g., particles of higher fatty acid metal salts typified by zinc stearate and fluoropolymers).

The amount of external additive added is preferably 0.01 mass % or more and 5 mass % or less, more preferably 0.01 mass % or more and 2.0 mass % or less relative to the mass of the toner particles.

### Image Forming Apparatus and Image Forming Method

An image forming apparatus according to an exemplary embodiment includes an image carrying member, a charging device that charges a surface of the image carrying member, an electrostatic image forming device that forms an electrostatic image on the charged surface of the image carrying member, a developing device that contains an electrostatic image developer and develops the electrostatic image formed on the surface of the image carrying member with the electrostatic image developer to form a toner image, a transfer device that transfers the toner image formed on the surface of the image carrying member to a surface of a recording medium, and a fixing device that fixes the toner image transferred to the surface of the recording medium. As the electrostatic image developer, the electrostatic image developer according to the exemplary embodiment is used.

The image forming apparatus according to the exemplary embodiment executes an image forming method (an image forming method according to an exemplary embodiment) including charging a surface of an image carrying member, forming an electrostatic image on the charged surface of the image carrying member, developing the electrostatic image formed on the surface of the image carrying member with the electrostatic image developer according to the exemplary embodiment to form a toner image, transferring the toner image formed on the surface of the image carrying member to a surface of a recording medium, and fixing the toner image transferred to the surface of the recording medium.

The image forming apparatus according to the exemplary embodiment may be a known image forming apparatus: for example, a direct-transfer apparatus that transfers a toner image formed on a surface of an image carrying member directly to a recording medium; an intermediate-transfer apparatus that performs first transfer of a toner image formed on a surface of an image carrying member to a surface of an intermediate transfer body and then performs second transfer of the toner image transferred to the surface of the intermediate transfer body to a surface of a recording medium; a cleaning device including a cleaning unit that cleans a surface of an image carrying member after the transfer of a toner image and before charging; or an erasing device including an erasing unit that erases charge on a surface of an image carrying member by irradiation with erasing light after the transfer of a toner image and before charging.

When the image forming apparatus according to the exemplary embodiment is an intermediate-transfer apparatus, the transfer device has a configuration including, for example, an intermediate transfer body having a surface to which a toner image is transferred, a first transfer unit that performs first transfer of a toner image formed on a surface of an image carrying member to the surface of the intermediate transfer body, and a second transfer unit that performs second transfer of the toner image transferred to the surface of the intermediate transfer body to a surface of a recording medium.

In the image forming apparatus according to the exemplary embodiment, the section including the developing device may be, for example, a cartridge structure (process cartridge) attachable to and detachable from the image forming apparatus. As the process cartridge, for example, a process cartridge containing the electrostatic image developer according to the exemplary embodiment and including a developing device is suitable for use.

A non-limiting example of the image forming apparatus according to the exemplary embodiment will be described below. In the following description, main parts illustrated in the drawings are described, and the description of other parts is omitted.

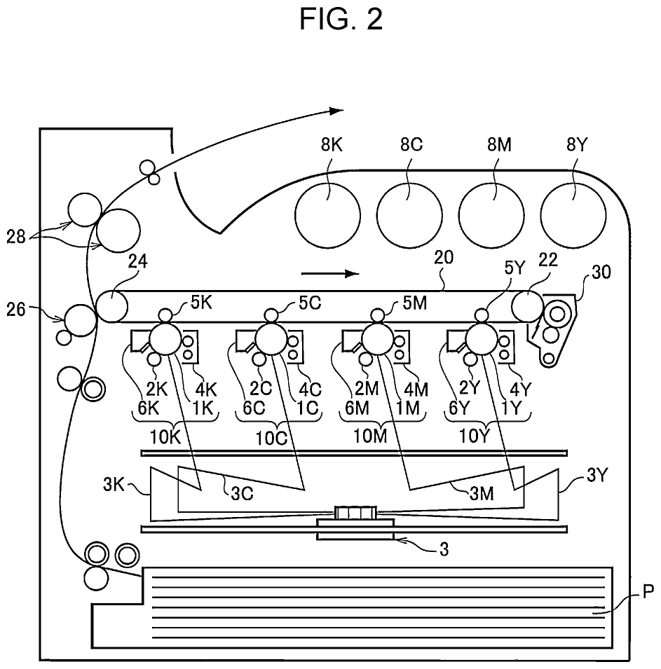

FIG. 2 illustrates a schematic configuration of the image forming apparatus according to the exemplary embodiment.

The image forming apparatus illustrated in FIG. 2 includes first to fourth electrophotographic image forming units 10Y, 10M, 10C, and 10K which respectively output yellow (Y), magenta (M), cyan (C), and black (K) images based on color-separated image data. These image forming units (hereinafter also referred to simply as “units”) 10Y, 10M, 10C, and 10K are arranged side by side at predetermined intervals from each other in the horizontal direction. These units 10Y, 10M, 10C, and 10K may be process cartridges attachable to and detachable from the image forming apparatus.

An intermediate transfer belt 20 (an example of the intermediate transfer body) extends above the units 10Y, 10M, 10C, and 10K so as to pass through the units. The intermediate transfer belt 20 is wound around a drive roller 22 and a support roller 24 and is configured to run in the direction from the first unit 10Y toward the fourth unit 10K. A spring or the like (not shown) applies a force to the support roller 24 in the direction away from the drive roller 22, so that tension is applied to the intermediate transfer belt 20 wound around the rollers 22 and 24. An intermediate transfer body cleaning device 30 is provided on the image carrying member side of the intermediate transfer belt 20 so as to face the drive roller 22. The units 10Y, 10M, 10C, and 10K respectively include developing devices 4Y, 4M, 4C, and 4K to which yellow, magenta, cyan, and black toners are respectively supplied from toner cartridges 8Y, 8M, 8C, and 8K.

The first to fourth units 10Y, 10M, 10C, and 10K have the same configuration and operation, and thus the first unit 10Y, which is disposed upstream in the running direction of the intermediate transfer belt and forms a yellow image, will be described here as a representative.

The first unit 10Y includes a photoreceptor 1Y, which functions as an image carrying member. The photoreceptor 1Y is surrounded by, in sequence, a charging roller 2Y (an example of the charging device), which charges the surface of the photoreceptor 1Y to a predetermined potential, an exposure device 3 (an example of the electrostatic image forming device), which exposes the charged surface to a laser beam 3Y based on a color-separated image signal to form an electrostatic image, a developing device 4Y, which supplies a charged toner to the electrostatic image to develop the electrostatic image, a first transfer roller 5Y (an example of the first transfer unit), which transfers the developed toner image onto the intermediate transfer belt 20, and a photoreceptor cleaning device 6Y (an example of the cleaning device), which removes the toner remaining on the surface of the photoreceptor 1Y after the first transfer.

The first transfer roller 5Y is disposed inside the intermediate transfer belt 20 so as to face the photoreceptor 1Y. The first transfer rollers 5Y, 5M, 5C, and 5K of the units are each connected to a bias power supply (not shown) that applies a first transfer bias. The value of transfer bias applied from each bias power supply to each first transfer roller is changed by control of a controller (not shown).

The operation of the first unit 10Y to form a yellow image will be described below. Prior to the operation, the charging roller 2Y charges the surface of the photoreceptor 1Y to a potential of −600 V to −800 V.

The photoreceptor 1Y is formed of a conductive substrate (for example, having a volume resistivity of 1×10⁻⁶ Ω·cm or less at 20° C.) and a photosensitive layer stacked on the substrate. The photosensitive layer, which normally has high resistivity (resistivity of common resins), has the property of, upon irradiation with a laser beam, changing its resistivity in an area irradiated with the laser beam. The exposure device 3 applies the laser beam 3Y to the charged surface of the photoreceptor 1Y on the basis of yellow image data sent from the controller (not shown). As a result, an electrostatic image with a yellow image pattern is formed on the surface of the photoreceptor 1Y.

The electrostatic image is an image formed on the surface of the photoreceptor 1Y by charging, i.e., a negative latent image formed in the following manner: in the area of the photosensitive layer irradiated with the laser beam 3Y, the resistivity decreases, and the charge on the surface of the photoreceptor 1Y dissipates from the area, while the charge remains in the area not irradiated with the laser beam 3Y.

As the photoreceptor 1Y runs, the electrostatic image formed on the photoreceptor 1Y is rotated to a predetermined development position. At the development position, the electrostatic image on the photoreceptor 1Y is developed by the developing device 4Y to form a visible toner image.

The developing device 4Y contains, for example, an electrostatic image developer containing at least a yellow toner and a carrier. The yellow toner is frictionally charged as it is stirred inside the developing device 4Y, and thus has a charge with the same polarity (negative) as that of the charge on the photoreceptor 1Y and is held on a developer roller (an example of the developer holding member). As the surface of the photoreceptor 1Y passes through the developing device 4Y, the yellow toner is electrostatically attached to the neutralized latent image portion on the surface of the photoreceptor 1Y, so that the latent image is developed with the yellow toner. The photoreceptor 1Y on which the yellow toner image is formed continues to run at a predetermined speed, and the toner image developed on the photoreceptor 1Y is transported to a predetermined first transfer position.

When the yellow toner image on the photoreceptor 1Y is transported to the first transfer position, a first transfer bias is applied to the first transfer roller 5Y, and electrostatic force directed from the photoreceptor 1Y toward the first transfer roller 5Y acts on the toner image to transfer the toner image on the photoreceptor 1Y onto the intermediate transfer belt 20. The transfer bias applied at this time has polarity (positive) opposite to the polarity (negative) of the toner and is controlled to, for example, +10 A by the controller (not shown) in the first unit 10Y.

The toner remaining on the photoreceptor 1Y is removed and collected by the photoreceptor cleaning device 6Y.

The first transfer biases applied to the first transfer rollers 5M, 5C, and 5K of the second to fourth units 10M, 10C, and 10K are controlled in the same manner as in the first unit. Thus, the intermediate transfer belt 20 to which the yellow toner image is transferred by the first unit 10Y is sequentially transported through the second to fourth units 10M, 10C, and 10K, and as a result, toner images of the respective colors are transferred in a superimposed manner.

The intermediate transfer belt 20, to which the toner images of the four colors are transferred in a superimposed manner through the first to fourth units, runs to a second transfer section including the intermediate transfer belt 20, the support roller 24 in contact with the inner surface of the intermediate transfer belt, and a second transfer roller 26 (an example of the second transfer unit) disposed on the image carrying member side of the intermediate transfer belt 20. A sheet of recording paper P (an example of the recording medium) is fed into the nip between the second transfer roller 26 and the intermediate transfer belt 20 at a predetermined timing by a feed mechanism, and a second transfer bias is applied to the support roller 24. The transfer bias applied at this time has the same polarity (negative) as the polarity (negative) of the toner, and electrostatic force directed from the intermediate transfer belt 20 toward the recording paper P acts on the toner image to transfer the toner image on the intermediate transfer belt 20 onto the recording paper P. The second transfer bias at this time is determined depending on the resistance detected by a resistance detector (not shown) that detects the resistance of the second transfer section, and is voltage-controlled.

The recording paper P is then sent to a pressure-contact part (nip part) between a pair of fixing rollers of a fixing device 28, and the toner image is fixed onto the recording paper P, thus forming a fixed image.

Examples of the recording paper P to which the toner image is transferred include plain paper for use in electrophotographic copiers, printers, and other devices. Examples of recording media other than the recording paper P include OHP sheets.

To further improve the surface smoothness of the fixed image, the surface of the recording paper P may also be smooth, and for example, coated paper, i.e., plain paper coated with resin or the like and art paper for printing are suitable for use.

The recording paper P after completion of the fixing of the color image is conveyed to a discharge unit, completing the series of color image forming operations.

### Process Cartridge

A process cartridge according to an exemplary embodiment includes a developing device that contains the electrostatic image developer according to the exemplary embodiment and that develops an electrostatic image formed on a surface of an image carrying member with the electrostatic image developer to form a toner image, and is attachable to and detachable from an image forming apparatus.

The process cartridge according to the exemplary embodiment need not necessarily have the above configuration and may have a configuration including a developing device and optionally at least one selected from other devices such as an image carrying member, a charging device, an electrostatic image forming device, and a transfer device.

A non-limiting example of the process cartridge according to the exemplary embodiment will be described below. In the following description, main parts illustrated in the drawings are described, and the description of other parts is omitted.

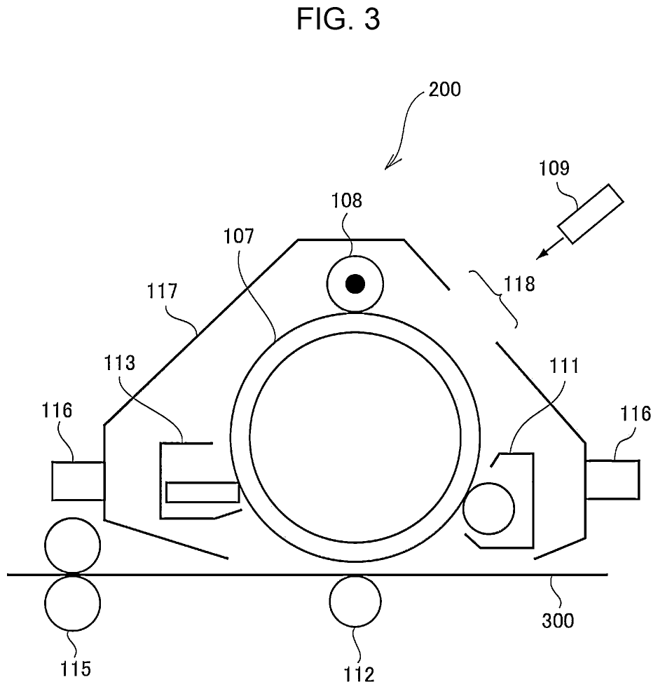

FIG. 3 illustrates a schematic configuration of the process cartridge according to the exemplary embodiment.

A process cartridge 200 illustrated in FIG. 3 is configured as a cartridge, for example, such that a photoreceptor 10⁷ (an example of the image carrying member), a charging roller 108 (an example of the charging device) disposed on the periphery of the photoreceptor 10⁷, a developing device 111, and a photoreceptor cleaning device 113 (an example of the cleaning device) are integrally combined and held by a housing 117 provided with mounting rails 116 and an opening 118 for exposure.

In FIG. 3, 10⁹ represents an exposure device (an example of the electrostatic image forming device), 112 represents a transfer device, 115 represents a fixing device, and 300 represents recording paper (an example of the recording medium).

### Examples

The exemplary embodiments of the disclosure will now be described in detail with reference to Examples, but these Examples are not intended to limit the exemplary embodiments of the disclosure. In the following description, “parts” and “%” are by mass unless otherwise specified.

### Production of Ferrite Particles

### Production of Ferrite Particles (1)

Fe₂O₃ (1318 parts), Mn(OH)₂ (587 parts), and Mg(OH)₂ (96 parts) are mixed and calcined at a temperature of 900° C. for 4 hours. The calcined product, polyvinyl alcohol (6.6 parts), polycarboxylic acid (0.5 parts) serving as a dispersant, and zirconia beads with a median diameter of 1 mm are put into water, and pulverized and mixed using a sand mill to obtain a dispersion. The particles in the dispersion have a volume-average particle size of 1.5 m.

Using the dispersion as a raw material, particle formation and drying are performed using a spray dryer to obtain a particulate substance having a volume-average particle size of 33 μm. Next, in an oxygen-nitrogen mixed atmosphere with an oxygen partial pressure of 1.2%, main firing is performed using an electric furnace at a temperature of 1350° C. for 4 hours, and then heating is performed in the air at a temperature of 850° C. for 3 hours to obtain fired particles. The fired particles are crushed and classified to obtain ferrite particles (1) having a number-average particle size of 30 μm. The ferrite particles (1) obtained have internal pores and an internal porosity of 5%.

### Production of Ferrite Particles (6)

Ferrite particles (6) having a number-average particle size of 30 μm are obtained in the same manner as the ferrite particles (1) except that the main firing is performed at an oxygen partial pressure of 1.4% and a temperature of 1250° C. The ferrite particles (6) obtained have internal pores and an internal porosity of 8%.

### Production of Ferrite Particles (16)

Ferrite particles (16) having a number-average particle size of 30 μm are obtained in the same manner as the ferrite particles (1) except that the main firing is performed at an oxygen partial pressure of 1.6% and a temperature of 1150° C. The ferrite particles (16) obtained have internal pores and an internal porosity of 12%.

### Production of Ferrite Particles (101)

Ferrite particles (101) having a number-average particle size of 31 μm are obtained in the same manner as the ferrite particles (1) except that the main firing is performed at an oxygen partial pressure of 1.3% and a temperature of 1325° C. and the heating in the air is performed at a temperature of 900° C. The ferrite particles (101) obtained have internal pores and an internal porosity of 6%.

### Production of Ferrite Particles (102)

Ferrite particles (102) having a number-average particle size of 31 μm are obtained in the same manner as the ferrite particles (101) except that the main firing is performed at an oxygen partial pressure of 0.5% and a temperature of 1500° C. The ferrite particles (102) obtained have internal pores and an internal porosity of 2%.

### Production of Ferrite Particles (103)

Ferrite particles (103) having a number-average particle size of 31 μm are obtained in the same manner as the ferrite particles (101) except that the main firing is performed at an oxygen partial pressure of 1.5% and a temperature of 1200° C. The ferrite particles (103) obtained have internal pores and an internal porosity of 10%.

### Production of Ferrite Particles (104)

Ferrite particles (104) having a number-average particle size of 31 μm are obtained in the same manner as the ferrite particles (101) except that the main firing is performed at an oxygen partial pressure of 0.5% and a temperature of 1550° C. The ferrite particles (104) obtained have internal pores and an internal porosity of 1%.

### Production of Ferrite Particles (105)

Ferrite particles (105) having a number-average particle size of 31 μm are obtained in the same manner as the ferrite particles (101) except that the main firing is performed at an oxygen partial pressure of 1.6% and a temperature of 1150° C. The ferrite particles (105) obtained have internal pores and an internal porosity of 12%.

### Production of Coating Agent

The following coating agents (1) to (5) and (7) to (14) are prepared as resin liquids each serving as both a resin liquid for specific resin composition disposition and a resin liquid for resin coating layer formation.

### Production of Coating Agent (1)

Resin (1): cyclohexyl methacrylate polymer (weight-average molecular weight: 350,000) 15.4 parts
Resin (2): 2-(dimethylamino)ethyl methacrylate polymer (weight-average molecular weight: 300,000) 0.39 parts
Specific inorganic particles (1): silica (number-average particle size: 12 nm, fumed silica particles surface-treated with hexamethyldisilazane) 9.0 parts
Conductive particles (1): carbon black (number-average particle size: 30 nm, product name: Vulcan XC72 manufactured by Cabot Corporation) 2.24 parts
Nitrogen-containing resin particles: melamine resin particles (EPOSTAR S (manufactured by Nippon Shokubai Co., Ltd.)) 3.0 parts
Solvent: toluene 150 parts

The above materials and glass beads (1 mm in diameter, the same amount as that of toluene) are put in a sand mill and stirred at a rotation speed of 190 rpm for 30 minutes to obtain a coating agent (1).

### Production of Coating Agents (2) to (5)

Coating agents (2) to (5) are obtained in the same manner as the coating agent (1) except that the specific inorganic particles (1) are added in amounts of 14.4 parts, 5.4 parts, 18 parts, and 3.6 parts, respectively.

### Production of Coating Agents (7) to (10)

Coating agents (7) to (10) are obtained in the same manner as the coating agent (1) except that the following specific inorganic particles (7) to (10) are respectively added in the following amounts instead of the specific inorganic particles (1).
Specific inorganic particles (7): silica (number-average particle size: 5 nm, fumed silica particles surface-treated with hexamethyldisilazane) 9.0 parts
Specific inorganic particles (8): silica (number-average particle size: 90 nm, fumed silica particles surface-treated with hexamethyldisilazane) 9.0 parts
Specific inorganic particles (9): alumina (number-average particle size: 13 nm, alumina particles surface-treated with octylsilane) 9.0 parts
Specific inorganic particles (10): calcium carbonate (number-average particle size: 40 nm, calcium carbonate particles not subjected to hydrophobic treatment) 9.0 parts

### Production of Coating Agents (11) and (12)

Coating agents (11) and (12) are obtained in the same manner as the coating agent (1) and the coating agent (7), respectively, except that the following conductive particles (11) are added in the following amount instead of the conductive particles (1).
Conductive particles (11): carbon black (number-average particle size: 55 nm, product name: #3030B manufactured by Mitsubishi Chemical Corporation) 2.24 parts

### Production of Coating Agent (13)

A coating agent (13) is obtained in the same manner as the coating agent (1) except that the resin (2) is not added.

### Production of Coating Agent (14)

A coating agent (14) is obtained in the same manner as the coating agent (1) except that the specific inorganic particles (1) are not added.

The following resin liquids are prepared as a resin liquid for specific resin composition disposition and a resin liquid for resin coating layer formation.

### Production of Resin Liquid

### Production of Resin Liquid (1-1)

Resin: cyclohexyl methacrylate polymer (weight-average molecular weight: 150,000) 5.2 parts
Specific inorganic particles (1): silica (number-average particle size: 12 nm, fumed silica particles surface-treated with hexamethyldisilazane) 0.25 parts
Solvent: toluene 100 parts

The above materials and glass beads (1 mm in diameter, the same amount as that of toluene) are put in a sand mill and stirred at a rotation speed of 500 rpm for 30 minutes to obtain a resin liquid (1-1).

### Preparation of Resin Liquids (1-2) to (1-15) and Resin Liquids (2-1) to (2-12)

Resin liquids (1-2) to (1-15) and resin liquids (2-1) to (2-12) are obtained in the same manner as the resin liquid (1-1) except that the amount of the resin added, the type and amount of the specific inorganic particles added, and the amount of the solvent added are changed as shown in Tables 1 and 2.

TABLE 1

| | Resin | Inorganic particles | | | | Solvent | |
|---|---|---|---|---|---|---|---|
| | Amount | | | Number- | Amount | Amount | |
| | added | | | average | added | added | |
| Resin | (parts by | | | particle size | (parts by | (parts by | Viscosity |
| liquid | mass) | No. | Material | (nm) | mass) | mass) | (mPa · s) |
| (1-1) | 5.2 | (1) | Silica | 12 | 0.25 | 100 | 20 |
| (1-2) | 5.4 | (1) | Silica | 12 | 0.08 | 100 | 12 |
| (1-3) | 5.0 | (1) | Silica | 12 | 0.41 | 100 | 20 |
| (1-4) | 3.6 | (1) | Silica | 12 | 1.77 | 100 | 10 |
| (1-5) | 4.9 | (1) | Silica | 12 | 0.57 | 100 | 15 |
| (1-6) | 2.0 | (1) | Silica | 12 | 0.09 | 50 | 20 |
| (1-7) | 8.6 | (1) | Silica | 12 | 0.41 | 175 | 20 |
| (1-8) | 10.5 | (1) | Silica | 12 | 0.49 | 200 | 20 |
| (1-9) | 4.8 | (9) | Alumina | 13 | 0.47 | 100 | 7 |
| (1-10) | 4.8 | — | — | — | — | 100 | 5 |
| (1-11) | 5.4 | — | — | — | — | 100 | 6 |
| (1-12) | 4.8 | (1) | Silica | 12 | 0.59 | 100 | 14 |
| (1-13) | 5.2 | (7) | Silica | 5 | 0.25 | 100 | 25 |
| (1-14) | 5.2 | (8) | Silica | 90 | 0.25 | 100 | 15 |
| (1-15) | 5.2 | (1) | Silica | 12 | 0.04 | 100 | 10 |

TABLE 2

| | Resin | Inorganic particles | | | | Solvent | |
|---|---|---|---|---|---|---|---|
| | Amount | | | Number- | Amount | Amount | |
| | added | | | average | added | added | |
| Resin | (parts by | | | particle size | (parts by | (parts by | Viscosity |
| liquid | mass) | No. | Material | (nm) | mass) | mass) | (mPa · s) |
| (2-1) | 59.5 | (1) | Silica | 12 | 25.5 | 500 | 40 |
| (2-2) | 76.5 | (1) | Silica | 12 | 8.5 | 500 | 25 |
| (2-3) | 42.5 | (1) | Silica | 12 | 42.5 | 500 | 50 |
| (2-4) | 78.0 | (1) | Silica | 12 | 6.8 | 500 | 20 |
| (2-5) | 41.0 | (1) | Silica | 12 | 44.4 | 500 | 50 |
| (2-6) | 62.0 | (1) | Silica | 12 | 26.6 | 500 | 40 |
| (2-7) | 57.0 | (1) | Silica | 12 | 24.4 | 500 | 40 |
| (2-8) | 55.5 | (1) | Silica | 12 | 23.8 | 500 | 40 |
| (2-9) | 60.0 | (9) | Alumina | 13 | 25.7 | 500 | 15 |
| (2-10) | 85.0 | — | — | — | — | 500 | 10 |
| (2-11) | 59.5 | (7) | Silica | 5 | 25.5 | 500 | 50 |
| (2-12) | 59.5 | (8) | Silica | 90 | 25.5 | 500 | 25 |

### Production of Carrier

### Production of Carrier (1)

In a vacuum degassing kneader, 1000 parts of the ferrite particles (1) and 180 parts of the coating agent (1) are placed and stirred at 75° C. and −20 kPa (gauge pressure) for 2 hours, after which the temperature is raised to 85° C., and toluene is distilled off under a vacuum of −90 kPa (gauge pressure), thereby forming a carrier in which the ferrite particles are coated with resin. Subsequently, fine powder and coarse powder are removed with an Elbow-Jet to obtain a carrier (1). The average thickness of a resin coating layer in the carrier (1) is 1.10 μm.

Observation of a cross section of the carrier (1) obtained reveals that a specific resin composition containing silica and resin is disposed in the internal pores of the ferrite particles (1). The area ratio (SP/SR) and the area ratio (SC/SP) of the specific resin composition are determined by the above-described method; the results are shown in Table 3.

### Production of Carriers (2) to (5) and (7) to (14)

Carriers (2) to (5) and (7) to (14) are obtained in the same manner as the carrier (1) except that coating agents (2) to (5) and (7) to (14) are respectively used instead of the coating agent (1). The average thicknesses of resin coating layers in the carriers (2) to (5) and (7) to (14) are 1.26 μm, 0.99 μm, 1.36 μm, 0.93 μm, 1.10 μm, 1.10 μm, 1.00 μm, 1.05 μm, 1.1 μm, 1.1 μm, 1.09 μm, and 0.81 μm, respectively.

Observation of cross sections of the carriers (2) to (5) and (7) to (13) obtained reveals that in every cross section, a specific resin composition containing silica and resin is disposed in the internal pores of the ferrite particles (1). The area ratio (SP/SR) and the area ratio (SC/SP) of the specific resin composition are determined by the above-described method; the results are shown in Table 3.

Observation of a cross section of the carrier (14) reveals that the resin alone is disposed in the internal pores of the ferrite particles (1).

### Production of Carrier (6)

A carrier (6) is obtained in the same manner as the carrier (1) except that the ferrite particles (6) are used instead of the ferrite particles (1). The average thickness of a resin coating layer in the carrier (6) is 1.10 μm.

Observation of a cross section of the carrier (6) obtained reveals that a specific resin composition containing silica and resin is disposed in the internal pores of the ferrite particles (6). The area ratio (SP/SR) and the area ratio (SC/SP) of the specific resin composition are determined by the above-described method; the results are shown in Table 3.

### Production of Carrier (15)

In a vacuum degassing kneader, 1000 parts of the ferrite particles (1) and 180 parts of the coating agent (1) are placed and stirred at 60° C. and −20 kPa (gauge pressure) for 1 hour, after which the temperature is raised to 70° C., and toluene is distilled off under a vacuum of −75 kPa (gauge pressure), thereby forming a carrier in which the ferrite particles are coated with resin. Subsequently, fine powder and coarse powder are removed with an Elbow-Jet to obtain a carrier (15). The average thickness of a resin coating layer in the carrier (15) is 1.10 m.

Observation of a cross section of the carrier (15) obtained reveals that neither silica nor resin is disposed in the internal pores of the ferrite particles (1).

### Production of Carrier (16)

A carrier (16) is obtained in the same manner as the carrier (1) except that the ferrite particles (16) are used instead of the ferrite particles (1). The average thickness of a resin coating layer in the carrier (16) is 1.10 μm.

Observation of a cross section of the carrier (16) obtained reveals that a specific resin composition containing silica and resin is disposed in the internal pores of the ferrite particles (16). The area ratio (SP/SR) and the area ratio (SC/SP) of the specific resin composition are determined by the above-described method; the results are shown in Table 3.

### Production of Carrier (101)

In a vacuum degassing kneader, 3000 parts of the ferrite particles (101) and 100 parts of the resin liquid (1-1) are placed, the temperature is raised to 50° C. at normal pressure, and mixing and stirring is performed for 30 minutes (first step). Thereafter, 730 parts of the resin liquid (2-1) is added, the temperature is raised to 70° C., and stirring is performed at −80 kPa (gauge pressure) for 1 hour (second step). Thereafter, the temperature is raised to 80° C., and toluene is distilled off at a reduced pressure of −90 kPa (gauge pressure). Fine powder and coarse powder are then removed with an Elbow-Jet to obtain a carrier (101). The average thickness of a resin coating layer in the carrier (101) is 1.02 μm.

Observation of a cross section of the carrier (101) obtained reveals that a specific resin composition containing silica and resin is disposed in the internal pores of the ferrite particles (101) and the specific resin composition and the resin coating layer are connected to each other. The area ratio A of the resin coating layer (“A” in Table), the area ratio B of the specific resin composition (“B” in Table), and the value of area ratio B/area ratio A (“B/A” in Table) are determined by the above-described method; the results are shown in Table 4.

### Production of Carriers (102) to (120)

Carriers (102) to (120) are obtained in the same manner as the carrier (101) except that the type of the ferrite particles used, the type of the resin liquid used in the first step, and the type of the resin liquid used in the second step are changed as shown in Table 4. In the column of Resin liquid in Table given below, “-” means that the step is omitted. The average thicknesses of resin coating layers in the carriers (102) to (120) are 0.97 m, 1.05 μm, 0.95 μm, 1.05 μm, 1.02 μm, 1.02 μm, 1.02 μm, 1.02 μm, 1 μm, 0.98 μm, 0.95 m, 1.03 μm, 1.1 μm, 0.98 μm, 1.1 μm, 0.95 μm, 0.93 μm, 1.0 μm, and 1.02 μm, respectively. Observation of cross sections of the carriers (102) to (115), (118), and (120) obtained reveals that in every cross section, a specific resin composition containing silica and resin is disposed in the internal pores of the ferrite particles and the specific resin composition and the resin coating layer are connected to each other. Observation of cross sections of the carriers (116) and (117) reveals that the resin alone is disposed in the internal pores of the ferrite particles. Observation of a cross section of the carrier (119) reveals that neither resin nor inorganic particles are disposed in the internal pores of the ferrite particles.

For the carriers obtained, the area ratio A of the resin coating layer (“A” in Table), the area ratio B of the specific resin composition (“B” in Table), and the value of area ratio B/area ratio A (“B/A” in Table) are determined by the above-described method; the results are shown in Table 4.

### Production of Developer

Any of the carriers (1) to (16) and (101) to (120) obtained and a toner obtained by a method described later are placed in a V-blender at a mixing ratio of carrier:toner=100:10 (mass ratio) and stirred for 20 minutes to obtain developers (1) to (16) and (101) to (120), respectively.

### Evaluations

### Evaluation of Density Unevenness of Solid Image

A modified version of an image forming apparatus Apeos C4030 (manufactured by FUJIFILM Business Innovation Corp.), which employs a developing system in which an AC voltage is applied, is provided, and the developers obtained are each put in a developing unit. A cyan test image (solid image) with an area coverage of 100% is printed on 50,000 sheets of A3 paper at high temperature and high humidity (35° C. and 75% RH). In the 50,000th image (test image), nine image portions are measured with an image density meter (X-Rite 938, manufactured by X-Rite, Incorporated), and the standard deviation a of densities E obtained is determined and evaluated according to the following evaluation criteria.

### Evaluation Criteria

A: The standard deviation a of densities E of a test image is less than 0.05.
B: The standard deviation a of densities E of a test image is 0.05 or more and less than 0.07.
B-: The standard deviation a of densities E of a test image is 0.07 or more and less than 0.10.
B--: The standard deviation a of densities E of a test image is 0.10 or more and less than 0.13.
C: The standard deviation a of densities E of a test image is 0.13 or more and less than 0.18.
D: The standard deviation a of densities E of a test image is 0.18 or more.
   Evaluation of Carrier Adhesion A modified version of an image forming apparatus DocuPrint Color3540 (manufactured by FUJIFILM Business Innovation Corp.) is provided, and the developers obtained are each placed in a developing unit. A cyan high-area-coverage image (solid image with an area coverage of 100%) is continuously formed on 100,000 sheets of A3 paper at high temperature and high humidity (28° C. and 85% RH), and the apparatus is then forced to stop after an image having two 2 cm×2 cm patches is formed. Thereafter, adhesive tape is pressed against a development portion on a photoreceptor, and the adhesive face of the tape is observed with a light microscope to count the number of adhering carriers (including crushed fine powder) per cm² of the adhesive face. This is performed on two development portions on the photoreceptor, and their average is determined and evaluated. The evaluation criteria are as follows, and G1 to G3 are acceptable levels. The results are shown in Table 4 (“Adhesion” in Table).

### Evaluation Criteria

G1: 0 to 1
G1.5: 2 to 3
G2: 4 to 5
G2.5: 6 to 7
G3: 8 to 9
G4: 10 to 11
G5: 12 or more

### Evaluation of Image Density

For each of the 1st image and the 100,000th image among the 100,000 solid images formed in the above evaluation of carrier adhesion, nine image portions are measured with an image density meter (X-Rite938, manufactured by X-Rite, Incorporated), and for each image, the average of densities E obtained is determined. The rate of change in density is determined by the following formula and evaluated according to the following evaluation criteria; in the formula, E1 is the average of densities E in the 1st image, and E2 is the average of densities E in the 100,000th image. The results are shown in Table 4 (“Density” in Table).

rate of decline=|(E1−E2)|/E1 Formula:

### Evaluation Criteria

G1: The rate of change is less than 0.05.
G2: The rate of change is 0.05 or more and less than 0.1.
G3: The rate of change is 0.1 or more and less than 0.2.

TABLE 3

| | | | | Specific inorganic | | | | |
|---|---|---|---|---|---|---|---|---|
| | | Magnetic | | particles | | | | |
| | | particles | | | Number- | | Conductive | |
| | | Internal | | | average | | particles | Evaluation |
| | | porosity | | | particle | Area ratio | Area ratio | Density |
| | Carrier | (%) | Resin type | Type | size (nm) | (SP/SR) | (SC/SP) | unevenness |
| Example 1 | (1) | 5 | CHMA | SiO₂ | 12 | 0.05 | 0.004 | A |
| | | | DMAEMA | | | | | |
| Example 2 | (2) | 5 | CHMA | SiO₂ | 12 | 0.09 | 0.002 | B-- |
| | | | DMAEMA | | | | | |
| Example 3 | (3) | 5 | CHMA | SiO₂ | 12 | 0.03 | 0.008 | B-- |
| | | | DMAEMA | | | | | |
| Example 4 | (4) | 5 | CHMA | SiO₂ | 12 | 0.11 | 0.0005 | C |
| | | | DMAEMA | | | | | |
| Example 5 | (5) | 5 | CHMA | SiO₂ | 12 | 0.01 | 0.012 | C |
| | | | DMAEMA | | | | | |
| Example 6 | (6) | 8 | CHMA | SiO₂ | 12 | 0.08 | 0.004 | B |
| | | | DMAEMA | | | | | |
| Example 7 | (7) | 5 | CHMA | SiO₂ | 5 | 0.06 | 0.003 | B |
| | | | DMAEMA | | | | | |
| Example 8 | (8) | 5 | CHMA | SiO₂ | 90 | 0.03 | 0.008 | B-- |
| | | | DMAEMA | | | | | |
| Example 9 | (9) | 5 | CHMA | Al₂O₃ | 13 | 0.06 | 0.005 | B |
| | | | DMAEMA | | | | | |
| Example 10 | (10) | 5 | CHMA | CaCO₃ | 40 | 0.03 | 0.006 | B- |
| | | | DMAEMA | | | | | |
| Example 11 | (11) | 5 | CHMA | SiO₂ | 12 | 0.05 | 0.002 | A |
| | | | DMAEMA | | | | | |
| Example 12 | (12) | 5 | CHMA | SiO₂ | 5 | 0.06 | 0.002 | B |
| | | | DMAEMA | | | | | |
| Example 13 | (13) | 5 | CHMA | SiO₂ | 12 | 0.05 | 0.004 | B |
| Example 14 | (16) | 12 | CHMA | SiO₂ | 12 | 0.12 | 0.004 | C |
| | | | DMAEMA | | | | | |
| Comparative | (14) | 5 | CHMA | — | — | 0.00 | — | D |
| Example 1 | | | DMAEMA | | | | | |
| Comparative | (15) | 5 | CHMA | SiO₂ | 12 | 0.00 | — | D |
| Example 2 | | | DMAEMA | | | | | |

TABLE 4

| | | | | First | Second | | | | | |
|---|---|---|---|---|---|---|---|---|---|---|
| | | Magnetic particles | | step | step | | | | | |
| | | | Internal | Resin | Resin | Area ratio | | | Evaluation | |
| | Carrier | Type | porosity (%) | liquid | liquid | A | B | B/A | Adhesion | Density |
| Example 101 | (101) | (101) | 6 | (1-1) | (2-1) | 30 | 5 | 0.15 | G1 | G1 |
| Example 102 | (102) | (101) | 6 | (1-2) | (2-2) | 10 | 2 | 0.15 | G2 | G1 |
| Example 103 | (103) | (101) | 6 | (1-3) | (2-3) | 50 | 8 | 0.15 | G2 | G1 |
| Example 104 | (104) | (101) | 6 | (1-2) | (2-4) | 8 | 1 | 0.15 | G2.5 | G1 |
| Example 105 | (105) | (101) | 6 | (1-3) | (2-5) | 52 | 8 | 0.15 | G2.5 | G1 |
| Example 106 | (106) | (101) | 6 | (1-4) | (2-1) | 30 | 33 | 1.10 | G2.5 | G1 |
| Example 107 | (107) | (101) | 6 | (1-2) | (2-1) | 30 | 1 | 0.04 | G2.5 | G1 |
| Example 108 | (108) | (101) | 6 | (1-5) | (2-1) | 30 | 11 | 0.35 | G2.5 | G1 |
| Example 109 | (109) | (102) | 2 | (1-6) | (2-6) | 30 | 5 | 0.15 | G1.5 | G1 |
| Example 110 | (110) | (103) | 10 | (1-7) | (2-7) | 30 | 5 | 0.15 | G1.5 | G1 |
| Example 111 | (111) | (104) | 1 | (1-1) | (2-1) | 30 | 5 | 0.15 | G2 | G1 |
| Example 112 | (112) | (105) | 12 | (1-8) | (2-8) | 30 | 5 | 0.15 | G2 | G1 |
| Example 113 | (113) | (101) | 6 | (1-9) | (2-9) | 30 | 9 | 0.30 | G1.5 | G2 |
| Example 114 | (114) | (101) | 6 | (1-13) | (2-11) | 45 | 8 | 0.18 | G1.5 | G1.5 |
| Example 115 | (115) | (101) | 6 | (1-14) | (2-12) | 20 | 3 | 0.15 | G2 | G2 |
| Example 116 | (120) | (101) | 6 | (1-15) | (2-1) | 30 | 0.04 | 0.001 | G3 | G1 |
| Comparative | (116) | (101) | 6 | (1-10) | (2-10) | 0 | 0 | 0 | G5 | G3 |
| Example 101 | | | | | | | | | | |
| Comparative | (117) | (101) | 6 | (1-11) | (2-1) | 30 | 0 | 0 | G4 | G3 |
| Example 102 | | | | | | | | | | |
| Comparative | (118) | (101) | 6 | (1-12) | (2-10) | 0 | 11 | — | G4 | G3 |
| Example 103 | | | | | | | | | | |
| Comparative | (119) | (101) | 6 | — | (2-1) | 30 | — | — | G5 | G3 |
| Example 104 | | | | | | | | | | |

The above results show that in Examples, compared with Comparative Examples, density unevenness of an image formed by a developing system in which an AC voltage is applied in a high-temperature and high-humidity environment is suppressed.

The abbreviations in Table are as follows.
CHMA: cyclohexyl methacrylate polymer
DMAEMA: 2-(dimethylamino)ethyl methacrylate polymer
Area ratio (SP/SR):ratio of total area SP of specific inorganic particles to total area SR of resin in cross section of specific resin composition
Area ratio (SC/SP):ratio of total area of conductive particles SC to total area SP of specific inorganic particles in cross section of specific resin composition

### Production of Toner

The toner used for the production of the above developers is obtained in by the following method.

### Preparation of Resin Particle Dispersion (1)

Ethylene glycol (FUJIFILM Wako Pure Chemical Corporation) 37 parts
Neopentyl glycol (FUJIFILM Wako Pure Chemical Corporation) 65 parts
1,9-Nonanediol (FUJIFILM Wako Pure Chemical Corporation) 32 parts
Terephthalic acid (FUJIFILM Wako Pure Chemical Corporation) 96 parts

The above materials are charged into a flask, the temperature is raised to 200° C. over 1 hour, and after it is confirmed that the inside of the reaction system is uniformly stirred, 1.2 parts of dibutyltin oxide is added. The temperature is raised to 240° C. over 6 hours while produced water is distilled off, and stirring is continued at 240° C. for 4 hours to obtain a polyester resin (acid value, 9.4 mgKOH/g; weight-average molecular weight, 13,000; glass transition temperature, 62° C.). This polyester resin, as it is in a molten state, is transferred to an emulsification disperser (CAVITRON CD1010, EUROTEC Co., Ltd.) at a rate of 100 g per minute. Separately, 0.37% dilute aqueous ammonia obtained by diluting a reagent-grade aqueous ammonia with ion-exchanged water is placed in a tank, and while being heated to 120° C. with a heat exchanger, the dilute aqueous ammonia is transferred to the emulsification disperser at a rate of 0.1 liter per minute concurrently with the polyester resin. The emulsification disperser is operated at a rotor rotation speed of 60 Hz and a pressure of 5 kg/cm² to obtain a resin particle dispersion (1) having a volume-average particle size of 160 nm and a solid content of 30%.

### Preparation of Resin Particle Dispersion (2)

Decanedioic acid (Tokyo Chemical Industry Co., Ltd.) 81 parts
Hexanediol (FUJIFILM Wako Pure Chemical Corporation) 47 parts

The above materials are charged into a flask, the temperature is raised to 160° C. over 1 hour, and after it is confirmed that the inside of the reaction system is uniformly stirred, 0.03 parts of dibutyltin oxide is added. The temperature is raised to 200° C. over 6 hours while produced water is distilled off, and stirring is continued at 200° C. for 4 hours. The reaction solution is then cooled and subjected to solid-liquid separation, and the solid is dried at a temperature of 40° C. under reduced pressure to obtain a polyester resin (C1) (melting point, 64° C.; weight-average molecular weight, 15,000).
Polyester resin (C1) 50 parts
Anionic surfactant (Neogen SC, DKS Co., Ltd.) 2 parts
Ion-exchanged water 200 parts

The above materials are heated to 120° C., sufficiently dispersed using a homogenizer (ULTRA-TURRAX T50, IKA), and then subjected to dispersion treatment using a pressure-discharge homogenizer. When the volume-average particle size reaches 180 nm, the resultant is collected to obtain a resin particle dispersion (2) having a solid content of 20%.

### Preparation of Colorant Particle Dispersion (1)

Cyan pigment (Pigment Blue 15:3, Dainichiseika Color & Chemicals Mfg. Co., Ltd.) 10 parts
Anionic surfactant (Neogen SC, DKS Co., Ltd.) 2 parts
Ion-exchanged water 80 parts

The above materials are mixed and dispersed for 1 hour using a high-pressure impact disperser (Ultimaizer HJP30006, Sugino Machine Limited) to obtain a colorant particle dispersion (1) having a volume-average particle size of 180 nm and a solid content of 20%.

### Preparation of Release Agent Particle Dispersion (1)

Paraffin wax (HNP-9, Nippon Seiro Co., Ltd.) 50 parts
Anionic surfactant (Neogen SC, DKS Co., Ltd.) 2 parts
Ion-exchanged water 200 parts

The above materials are heated to 120° C., sufficiently dispersed using a homogenizer (ULTRA-TURRAX T50, IKA), and then subjected to dispersion treatment using a pressure-discharge homogenizer. When the volume-average particle size reaches 200 nm, the resultant is collected to obtain a release agent particle dispersion (1) having a solid content of 20%.

### Preparation of Toner Particles

Resin particle dispersion (1) 150 parts
Resin particle dispersion (2) 50 parts
Colorant particle dispersion (1) 25 parts
Release agent particle dispersion (1) 35 parts
Polyaluminum chloride 0.4 parts
Ion-exchanged water 100 parts

The above materials are put in a round stainless-steel flask, sufficiently mixed and dispersed using a homogenizer (ULTRA-TURRAX T50, IKA), and then heated to 48° C. in a heating oil bath while the flask is stirred. After the inside of the reaction system is held at 48° C. for 60 minutes, 70 parts of the resin particle dispersion (1) is gently added. Subsequently, the pH is adjusted to 8.0 using a 0.5 mol/L aqueous sodium hydroxide solution, and the flask is hermetically sealed, heated to 90° C. while being kept stirred with a seal of the stirrer shaft being magnetically sealed, and held for 30 minutes. Subsequently, the resultant is cooled at a cooling rate of 5° C./min, subjected to solid-liquid separation, and thoroughly washed with ion-exchanged water. Subsequently, the resultant is subjected to solid-liquid separation, dispersed again in ion-exchanged water at 30° C., and washed by stirring at a rotation speed of 300 rpm for 15 minutes. This washing operation is further repeated six times, and when the pH and the electrical conductivity of the filtrate reaches reach 7.54 and 6.5 S/cm, respectively, solid-liquid separation is performed, and vacuum drying is continued for 24 hours to obtain toner particles (1) having a volume-average particle size of 5.7 μm.

### External Addition of Toner Particles

The toner particles (1) (100 parts) and hydrophobic silica (RY50 manufactured by Nippon Aerosil Co., Ltd.) (0.7 parts) are mixed using a Henschel mixer to obtain the toner.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A carrier for electrostatic image development, comprising:
magnetic particles having internal pores; and
a resin composition disposed in at least some of the internal pores and containing a
resin and inorganic particles including at least one selected from the group consisting of silica, alumina, and calcium carbonate.
   (((2)))

The carrier for electrostatic image development according to (((1))), wherein the magnetic particles have an internal porosity of 2% or more and 10% or less.

(((3)))

The carrier for electrostatic image development according to (((1))) or (((2))), wherein a ratio of a total area of the inorganic particles to a total area of the resin in a cross section of the resin composition is 0.02 or more and 0.10 or less.

(((4)))

The carrier for electrostatic image development according to any one of (((1))) to (((3))), wherein the resin composition does not contain conductive particles or contains the conductive particles such that a ratio of a total area of the conductive particles to a total area of the inorganic particles in a cross section of the resin composition is 0.005 or less.

(((5)))

The carrier for electrostatic image development according to any one of (((1))) to (((4))), wherein the inorganic particles have a number-average particle size of 5 nm or more and 90 nm or less.

(((6)))

The carrier for electrostatic image development according to any one of (((1))) to (((5))), wherein the resin includes a resin having a nitrogen atom.

(((7)))

The carrier for electrostatic image development according to (((6))), wherein the resin further includes a resin not having a nitrogen atom.

(((8)))

The carrier for electrostatic image development according to (((1))), comprising a resin coating layer covering the magnetic particles and containing a resin and inorganic particles.

(((9)))

The carrier for electrostatic image development according to (((8))), wherein when a ratio of a total area of the inorganic particles contained in the resin coating layer to an entire area of the resin coating layer in a cross section of the resin coating layer is an area ratio A, and a ratio of a total area of the inorganic particles contained in the resin composition to an entire area of the resin composition in a cross section of the resin composition is an area ratio B, the area ratio A is 10% or more and 50% or less, and area ratio A>area ratio B is satisfied.

(((10)))

The carrier for electrostatic image development according to (((9))), wherein the area ratio B is 0.05 to 0.3 times the area ratio A.

(((11)))

An electrostatic image developer comprising:
a toner for electrostatic image development; and
the carrier for electrostatic image development according to any one of (((1))) to (((10))).
   (((12)))

A process cartridge attachable to and detachable from an image forming apparatus, the process cartridge comprising a developing device that contains the electrostatic image developer according to (((11))) and develops an electrostatic image formed on a surface of an image carrying member with the electrostatic image developer to form a toner image.

(((13)))

An image forming apparatus comprising:
an image carrying member;
a charging device that charges a surface of the image carrying member;
an electrostatic image forming device that forms an electrostatic image on the charged surface of the image carrying member;
a developing device that contains the electrostatic image developer according to (((11))) and develops the electrostatic image formed on the surface of the image carrying member with the electrostatic image developer to form a toner image;
a transfer device that transfers the toner image formed on the surface of the image carrying member to a surface of a recording medium; and a fixing device that fixes the toner image transferred to the surface of the recording medium.
   (((14)))

An image forming method comprising:
charging a surface of an image carrying member;
forming an electrostatic image on the charged surface of the image carrying member;
developing the electrostatic image formed on the surface of the image carrying member with the electrostatic image developer according to (((11))) to form a toner image;
transferring the toner image formed on the surface of the image carrying member to a surface of a recording medium; and fixing the toner image transferred to the surface of the recording medium.

What is claimed is:

1. A carrier for electrostatic image development, comprising:
magnetic particles having internal pores; and
a resin composition disposed in at least some of the internal pores and containing a resin and inorganic particles including at least one selected from the group consisting of silica, alumina, and calcium carbonate.

2. The carrier for electrostatic image development according to claim 1, wherein the magnetic particles have an internal porosity of 2% or more and 10% or less.

3. The carrier for electrostatic image development according to claim 1, wherein a ratio of a total area of the inorganic particles to a total area of the resin in a cross section of the resin composition is 0.02 or more and 0.10 or less.

4. The carrier for electrostatic image development according to claim 1, wherein the resin composition does not contain conductive particles or contains the conductive particles such that a ratio of a total area of the conductive particles to a total area of the inorganic particles in a cross section of the resin composition is 0.005 or less.

5. The carrier for electrostatic image development according to claim 1, wherein the inorganic particles have a number-average particle size of 5 nm or more and 90 nm or less.

6. The carrier for electrostatic image development according to claim 1, wherein the resin includes a resin having a nitrogen atom.

7. The carrier for electrostatic image development according to claim 6, wherein the resin further includes a resin not having a nitrogen atom.

8. The carrier for electrostatic image development according to claim 1, comprising:
a resin coating layer covering the magnetic particles and containing a resin and inorganic particles.

9. The carrier for electrostatic image development according to claim 8, wherein when a ratio of a total area of the inorganic particles contained in the resin coating layer to an entire area of the resin coating layer in a cross section of the resin coating layer is an area ratio A, and a ratio of a total area of the inorganic particles contained in the resin composition to an entire area of the resin composition in a cross section of the resin composition is an area ratio B, the area ratio A is 10% or more and 50% or less, and area ratio A>area ratio B is satisfied.

10. The carrier for electrostatic image development according to claim 9, wherein the area ratio B is 0.05 to 0.3 times the area ratio A.

11. An electrostatic image developer comprising:
a toner for electrostatic image development; and
the carrier for electrostatic image development according to claim 1.

12. An electrostatic image developer comprising:
a toner for electrostatic image development; and
the carrier for electrostatic image development according to claim 2.

13. An electrostatic image developer comprising:
a toner for electrostatic image development; and
the carrier for electrostatic image development according to claim 3.

14. An electrostatic image developer comprising:
a toner for electrostatic image development; and
the carrier for electrostatic image development according to claim 4.

15. An electrostatic image developer comprising:
a toner for electrostatic image development; and
the carrier for electrostatic image development according to claim 5.

16. An electrostatic image developer comprising:
a toner for electrostatic image development; and
the carrier for electrostatic image development according to claim 6.

17. An electrostatic image developer comprising:
a toner for electrostatic image development; and
the carrier for electrostatic image development according to claim 7.

18. A process cartridge attachable to and detachable from an image forming apparatus, the process cartridge comprising a developing device that contains the electrostatic image developer according to claim 11 and develops an electrostatic image formed on a surface of an image carrying member with the electrostatic image developer to form a toner image.

19. An image forming apparatus comprising:
an image carrying member;
a charging device that charges a surface of the image carrying member;
an electrostatic image forming device that forms an electrostatic image on the charged surface of the image carrying member;
a developing device that contains the electrostatic image developer according to claim 11 and develops the electrostatic image formed on the surface of the image carrying member with the electrostatic image developer to form a toner image;
a transfer device that transfers the toner image formed on the surface of the image carrying member to a surface of a recording medium; and
a fixing device that fixes the toner image transferred to the surface of the recording medium.

20. An image forming method comprising:
charging a surface of an image carrying member;
forming an electrostatic image on the charged surface of the image carrying member;
developing the electrostatic image formed on the surface of the image carrying member with the electrostatic image developer according to claim 11 to form a toner image;
transferring the toner image formed on the surface of the image carrying member to a surface of a recording medium; and
fixing the toner image transferred to the surface of the recording medium.
